(19) United States
(12) Patent Application Publication
(10) Pub. No.: US 2021/0317012 A1
(43) Pub. Date: Oct. 14, 2021

(54) WATER TREATMENT SYSTEMS, AN ELECTRIC FILTRATION CELL, AND METHODS OF SEPARATING AND ACQUIRING CHARGED COMPOSITIONS, SUCH AS PHOSPHOROUS

(71) Applicant: University of Vermont and State Agricultural College, Burlington, VT (US)

(72) Inventors: Appala Raju Badireddy, Burlington, VT (US); Yuxiang Shen, Burlington, VT (US)

(21) Appl. No.: 17/272,782

(22) PCT Filed: Sep. 6, 2019
(86) PCT No.: PCT/US2019/049863

§ 371 Date: Mar. 2, 2021

Related U.S. Application Data
(60) Provisional application No. 62/787,488, filed on Jan. 2, 2019.
(60) Provisional application No. 62/727,719, filed on Sep. 6, 2018.

(51) Int. Cl. C02F 1/469; B01D 61/42; B01D 71/02; B01D 71/50

(52) U.S. Cl. CPC C02F 1/469; B01D 61/42; C02F 2101/105; B01D 71/50; B01D 71/021

(57) ABSTRACT

Methods and apparatus for use in a water treatment system to separate charged compositions from the water stream are provided. An electric filtration cell may include a fluid passageway, a filtration membrane, and a first and second electrode, configured to provide an oscillating electric field across the filtration membrane to separate charged compositions on a first side of the membrane. A water treatment system may be provided to separate charged compositions from a water stream. The water treatment system may include an electromagnetic field (EMF) device to generate an electromagnetic field within a passageway. The water treatment system may further include a filtration membrane and a first electrode and a second electrode, configured to provide an oscillating electric field across the filtration membrane to separate charged compositions. In one embodiment, the system is configured to separate struvite and/or vivianite on a first side of the membrane. In another embodiment, the system is configured to separate salt on a first side of the membrane.

### RELATED APPLICATIONS

The present application claims the benefit under 35 U.S.C. § 119(e) to U.S. Provisional Application No. 62/727,719 filed on Sep. 6, 2018 and to U.S. Provisional Application No. 62/787,488 filed on Jan. 2, 2019, the contents of each of which is incorporated by reference herein in its entirety.

### FIELD OF THE INVENTION

The invention relates, in part, to methods and systems for separating and acquiring charged compositions out of a fluid, such as water.

### BACKGROUND

In a filtration system, such as a water treatment system, it may be desirable to remove one or more compositions from the water stream, which may be considered contaminants in the water stream. For example, phosphorous-containing compositions may be present in water treatment systems. One example of a phosphorous-containing composition is struvite (magnesium ammonium phosphate hexahydrate or MgNH₄PO₄.6H₂O). Struvite is a crystalline compound formed when magnesium ammonium phosphate ions are dissolved in a waste stream's liquid water phase above saturation concentrations. A second example of a phosphorous-containing composition is vivianite, or hydrated ferrous phosphate; Fe₃(PO₄)₂.8H₂O. These compositions can build up on the surfaces clogging pipes, fouling valves and otherwise creating severe maintenance problems.

### SUMMARY OF THE INVENTION

In one embodiment, an electric filtration cell, for use in a water treatment system is provided, where the electric filtration cell is configured to separate charged compositions from a water stream. The electric filtration cell includes a fluid passageway, a filtration membrane positioned within the passageway, and a first electrode and a second electrode. The first and second electrodes are configured to selectively provide an oscillating electric field across the filtration membrane to separate charged compositions on a first side of the filtration membrane.

In another embodiment, a water treatment system configured to separate charged compositions from a water stream is provided. The water treatment system includes a fluid passageway, an electromagnetic field (EMF) device coupled to the passageway and configured to selectively generate an electromagnetic field within the passageway, and a filtration membrane positioned within the passageway. The water treatment system further includes a first electrode and a second electrode, where the first and second electrodes are configured to selectively provide an oscillating electric field across the filtration membrane to separate charged compositions on a first side of the filtration membrane.

In yet another embodiment, a method of using a filtration membrane in a water treatment system to separate charged compositions from a water stream is provided. The method includes providing a filtration membrane in a fluid passageway, flowing a fluid through the fluid passageway and through the filtration membrane, and generating an oscillating electromagnetic field across the filtration membrane to alter compositions in the fluid, such that the altered compositions remain on a first side of the filtration membrane.

In another embodiment, a method of using a filtration membrane in a water treatment system to separate charged compositions from a water stream is provided. The method includes providing a filtration membrane in a fluid passageway, flowing a fluid through the fluid passageway and through the filtration membrane and generating an electromagnetic field within the passageway at a location upstream from the filtration membrane to pretreat the water stream prior to the filtration membrane so that the charged compositions may precipitate out of solution. The method further includes generating an oscillating electromagnetic field across the filtration membrane to alter compositions in the fluid, such that the altered compositions remain on a first side of the filtration membrane.

### BRIEF DESCRIPTION OF THE DRAWINGS

FIG. 1 is an illustration of one embodiment of a water treatment system using dead-end membrane filtration to recover a composition, such as phosphorous, from the water.

FIG. 2 is an illustration of another embodiment of a water treatment system using electric field assisted membrane filtration to recover a composition, such as phosphorous, from the water.

FIGS. 3A and 3B are illustrations of various minerals/contaminants in wastewater streams. FIG. 3A illustrates minerals/contaminants in wastewater streams without treatment. FIG. 3B illustrates minerals/contaminants in wastewater streams with treatments which include pipe descaling technology (PDT).

FIG. 4A is an illustration of a baseline condition of a Belt Filter Press (BFP) before applying the below described pipe descaling technology (PDT). FIG. 4B is an illustration of a Belt Filter Press (BFP) Drum surface at the end of 90 day treatment of this pipe descaling technology (PDT).

FIG. 5 illustrates one embodiment of a dead-end membrane filtration employed to capture and recover PDT-altered struvite and/or vivianite mineral clusters.

FIG. 6 illustrates one embodiment of an oscillating electric field enhanced cross flow membrane filtration configured to capture and recover contaminants, such as struvite and/or vivianite clusters from PDT-treated streams.

FIG. 7 is a graphical representation of an exemplary experimental research framework showing the focus on testing and assessing the mechanisms of fouling control strategies using electromagnetic field (EMF) and oscillating electric field (OEF) on conductive membranes.

FIG. 8 is a table which illustrates a summary of feed water model foulants that may be employed according to one embodiment.

FIG. 9 illustrates an exemplary flow-mode apparatus fitted with an electromagnetic field (EMF) device.

FIG. 10 also illustrates an exemplary flow-mode apparatus fitted with an electromagnetic field (EMF) device. FIG. 10 includes section (i) which is a block diagram showing the transformation of scale-forming precursors going from the dissolved state to particle precipitation controlled by the frequency of the EMF. FIG. 10 also includes section (ii) and (iii) which illustrate an SEM analysis of the struvite precipitates collected from control and EMF-exposed samples showed need-like and sphere-like morphologies, respectively.

FIG. 11 illustrates a schematic of one embodiment of the flow-mode apparatus (feed line) equipped with EMF device connected to a membrane fouling simulator.

FIG. 12 illustrates a graphical representation of the effect of MWCNT-loading in membranes on water flux and foulant rejection (polyethylene glycol (PEG 20 kDa).

FIG. 13 illustrates Table 2, which includes various operating conditions for both UF and RO filtration membranes, including foulant, transmembrane pressure, cross flow velocity, and electric field strength, discussed in the Examples section.

FIG. 14 illustrates a graphical representation of transmembrane pressure on water flux and membrane surface concentration according to one embodiment.

FIG. 15 illustrates a table showing Ammonium concentrations according to Experiment 1.

FIG. 16 illustrates a table showing Ortho-phosphate Concentration from Experiment 1.

FIGS. 17A-17B illustrate Scanning Electron microscope images from Experiment 1.

FIGS. 18A-18D illustrate the energy dispersive X-ray spectroscopy of a 1 hour control sample from Experiment 1.

FIGS. 19A-19D illustrate the energy dispersive X-ray spectroscopy of a 1 hour experiment sample from Experiment 1.

FIGS. 20A and 20B illustrate the distribution of crystals that are formed in both the control and an EMF treated sample after 4 hours from Experiment 1.

FIGS. 21A-21D illustrate the energy dispersive X-ray spectroscopy of a 4 hour control sample from Experiment 1.

FIGS. 21A-D illustrate the EDS report of a 4 hour blank (control) sample from Experiment 1.

FIGS. 22A-22D illustrate the EDS report of a 4 hour experiment sample from Experiment 1.

FIG. 23 illustrates a table showing X-ray fluorescence spectrometer (XRF) results from Experiment 1.

FIGS. 24A and 24B illustrate the EMF exposed supernatant samples from Experiment 2.

FIG. 25A illustrates SEM showing the crystal morphology of large-sized crystals, and FIG. 25B illustrates Energy Dispersive Spectroscopy showing the elemental composition of a crystal from Experiment 2.

FIGS. 26A and 26B illustrate the scanning electron microscopy image and a photograph of the control supernatant sample from Experiment 2.

FIG. 27 illustrates a table of the X-ray fluorescence (XRF) Analysis of the Settled and Centrifuged Samples from Experiment 2.

### DETAILED DESCRIPTION

One aspect of the present disclosure is directed to a water treatment system, which is configured to remove one or more compositions (i.e. particles or contaminants), such as, but not limited to phosphorous-containing compositions. It is also contemplated that the water treatment system is configured to remove other compositions, such as, but not limited to dissolved salts, organic molecules, bacteria, and viruses, which may be precursors for scaling and biofouling within a water treatment system.

Aspects of the present disclosure are directed to a water treatment system with electromagnetic field-treated feed water. For example, as set forth in more detail below, the water treatment system may include a fluid passageway and an electromagnetic field (EMF) device coupled to the passageway and configured to selectively generate an electric field within the passageway. The EMF device may alter one or more properties of compositions in the feed water, which may assist in the removal of these compositions (i.e. contaminants) from the water. In one embodiment, the electromagnetic field is configured to alter a charged contaminant. Pipe Descaling Technology (PDT) which uses an induced electric field of variable amplitude and frequency is used to promote the precipitation of crystalline minerals (struvite). As set forth in greater detail below, in one embodiment, the EMF device may alter the shape of one or more of the compositions. For example, struvite precipitates may have a needle-like shape without the EMF device, but with the electromagnetic field, have a sphere-like shape. Experimentation has shown that the EMF device may cause molecular-level alterations that may occur in the feed water during the course of the exposure to the EMF. It is contemplated that the electromagnetic field may cause crystal growth, which may result in one or more of: (1) a reduction in the concentration of ions, (2) a change in a size of one or more of the particles, and (3) a change in the shape of one or more particles, thus the particles can be more easily captured and removed from the EMF-treated feed water. Particles may be defined as one or more compositions. For example, in one embodiment, a particle may be a cluster of the compositions. It is also contemplated that the electromagnetic field may alter the fundamental nature of the crystalline clusters making them softer, non-sticky, and easier to wash off from various surfaces.

Further aspects of the present disclosure are directed to a water treatment system with an electrically activated conductive membrane. For example, as set forth in more detail below, the water treatment system may include a filtration membrane, and a first electrode and a second electrode. The electrodes may be configured to provide an oscillating-field across the membrane. The electrically activated conductive membrane may help to prevent one or more charged compositions (i.e. contaminants) from depositing and forming scale on the membrane surfaces. In one embodiment, such a membrane may be configured in a dead end filtration system. In another embodiment, such a membrane may be configured in a cross flow filtration system.

It is contemplated that in a cross flow filtration system with an electrically activated conductive membrane, the oscillating particles (various charged compositions) may then be carried away by the cross flow, and thus removed from the feed water. This technique may be used to concentrate and recover various charged compositions, such as struvite and/or vivianite from waste water streams and it may also keep the membrane surface free of scale for a significant period of time. In some embodiments, concentrated compositions may be recovered and used in other applications.

As set forth in further detail below, in one embodiment, the electrically activated conductive membrane may be configured as an electric filtration cell configured to capture various compositions. In one embodiment, the electric filtration cell may be a custom-designed filtration cell that can be retrofitted into an existing water treatment system. In one embodiment, the electric filtration cell may be configured to be portable and it may be configured to be easily removed from the system as desired. This electric filtration cell may include the above described filtration membrane and electrode assembly and it may be retrofitted to existing waste water systems.

The electric filtration cell may utilize an oscillating electric-field assisted membrane filtration to recover phosphorous-containing minerals from wastewater streams. This may be termed an OEF Membrane (Oscillating Electric Field on Membrane). In one embodiment, the oscillating field may be provided with an Alternating-Current (AC) power source. In one embodiment, a continuous field alternating current may be provided. In another embodiment, a pulsed field alternating current may be provided. It is contemplated that an oscillating electric field may be advantageous over a Direct Current (DC) electric field for preventing the compositions from sticking to and/or becoming embedded within the filtration membrane.

It should be recognized that in one embodiment, the water treatment system may include both an electromagnetic field (EMF) device and an electrically activated conductive membrane. In another embodiment, the water treatment system may include an electromagnetic field (EMIF) device, without an electrically activated conductive membrane. In yet another embodiment, the water treatment system may include an electrically activated conductive membrane, without an electromagnetic field (EMF) device.

In water treatment system embodiments that include one or more filtration membranes, it is contemplated that the filtration membranes may be one or more of a microfiltration membrane, an ultrafiltration membrane, a nanofiltration membrane, and a reverse osmosis membrane. In one embodiment, the microfiltration membrane is configured to filter out particles that are larger than 0.1 μm, the ultrafiltration membrane is configured to filter out particles that are larger than 0.01 μm, the nanofiltration membrane is configured to filter out particles that are larger than 0.001 μm, and the reverse osmosis membrane is configured to filter out dissolved substances and particles that are larger than 0.0001 μm. It is contemplated that in one embodiment, a plurality of filtration membranes may be employed where different compositions may be recovered on different membranes based upon the characteristics and size of the membranes.

As set forth in more detail below, in one embodiment, a water treatment system includes one or more filtration membranes positioned between a first electrode and a second electrode. The first and second electrodes act as a cathode and an anode and can be activated with a low-frequency alternating current (AC) to provide an oscillating field across the membrane. In one embodiment, the filtration membrane may include an ultrafiltration membrane (UF) and a reverse osmosis (RO) membrane, although one of ordinary skill in the art will appreciate that other types and combinations of membranes are also contemplated.

In one embodiment, the first electrode is integrally formed with the filtration membrane. For example, the electrical activation of the filtration membranes may be achieved by membrane material modification with carboxyl-functionalized multi-walled carbon nanotubes (MWCNTs). MWCNT's have extraordinary electrical conductivity and mechanical strength, and thus can be used as both electrodes and membrane elements. In an embodiment of a cross flow filtration system, the discharge from the system is configured to flow tangentially on the membrane. In one embodiment, the anode (i.e. second electrode) is a graphite paper, the cathode (i.e. first electrode) is the MWCNT/UJF membrane and/or MWCNT/RO membrane mounted parallel to the flow path, and the membrane is supported by a porous polycarbonate structure. In some embodiments, the porous polycarbonate structure has a honeycomb configured structure.

Turning to FIG. 2, in one embodiment, an electric filtration cell 100 is provided for use in a water treatment system where the electric filtration cell is configured to separate charged compositions from a water stream. As shown in FIG. 2, the electric filtration cell 100 may include a fluid passageway 10 configured for the water stream to flow there through. The electric filtration cell 100 may also include a filtration membrane 20 positioned within the passageway 10, and a first electrode 30 and a second electrode 40, where the first and second electrodes 30, 40 are configured to selectively provide an oscillating electric field across the filtration membrane 20 to separate charged compositions 50 on a first side 22 of the filtration membrane. In one embodiment, the charged compositions 50 may be struvite-rich retentate.

As shown in FIG. 2, in one illustrative embodiment, the first electrode 30 is integrally formed with the filtration membrane 20. As mentioned above, the first electrode and the filtration membrane may be formed of carbon nanotubes. In one particular embodiment, the first electrode and the filtration membrane are formed of carboxyl-functionalized multi-walled carbon nanotubes (MWCNT). As also shown in FIG. 2, the filtration membrane 20 may include a framework, such as a porous polycarbonate structure for additional support. In one illustrative embodiment, the second electrode 40 is formed of graphite paper.

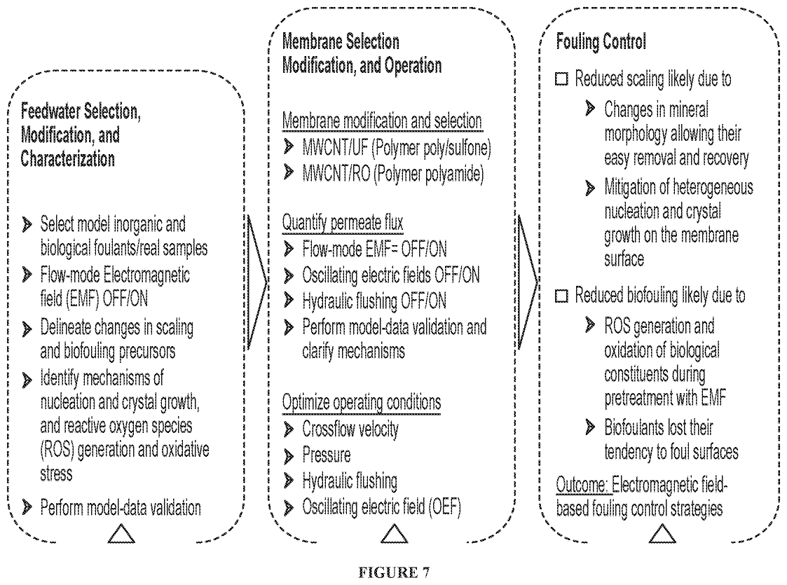

As shown in FIG. 6, in another illustrative embodiment, the first electrode 30 and the filtration membrane 20 are separately formed components. For example, as shown in FIG. 6, the filtration membrane 20 is positioned between the first electrode 30 and the second electrode 40.

As shown in both FIGS. 2 and 6, the electric filtration cell 100, 200 may include an Alternating-Current (AC) power source 60 configured to selectively provide an oscillating electric field across the filtration membrane 20. As set forth in more detail below, experimentation has shown that an oscillating electric field may be desirable to assist in the removal of the collected composition 50 from the first side 22 of the membrane 20. In particular, in contrast to a direct current electric field, the oscillating electric field may prevent the charged composition 50 from becoming embedded within the membrane 20. Thus, the charged composition 50 may be more easily removed and/or flushed from the membrane 20. Experimental details are discussed in greater detail below and also shown in FIGS. 13 and 14, but in one embodiment, the electric field strength of the oscillating electric field across the filtration membrane is at least 400 V/m, or at least 600 V/m, or at least 800 V/m, or at least 1000 V/m, or at least 1200 V/m, or at least 1400 V/m. Furthermore, in one embodiment, the frequency of the oscillating electric field across the filtration membrane is at least 0.5 Hz, or at least 1 Hz, or at least 10 Hz, or at least 20 Hz.

As shown in FIG. 2, a water treatment system may be provided to separate charged compositions from a water stream, where the water treatment system includes a fluid passageway 10 configured for the water stream to flow there through, and an electromagnetic field (EMF) device 110 coupled to the passageway 10 and configured to selectively generate an electromagnetic field within the passageway. In one embodiment, the EMF device 110 may be obtained from HYDROFLOW® USA of Redmond, Wash. The system may also include a filtration membrane 20 positioned, and a first electrode 30 and a second electrode 40 configured to selectively provide an oscillating electric field across the filtration membrane to separate charged compositions on a first side 22 of the filtration membrane 20. As mentioned above, in one embodiment, the filtration membrane 20, first electrode 30 and second electrode 40 may be configured as an electric filtration cell 100, 200. It is also contemplated that these components may be configured differently within the water treatment system, as the disclosure is not limited in this respect. In one embodiment, the EMF device 110 is configured to induce a signal into the passageway at a frequency of at least 1 kHz, or at least 20 kHz, or at least 100 kHz. As shown in FIG. 2, the system may also include a peristaltic pump 120 configured to flow water through the passageway 10.

As set forth in more detail below, in one embodiment, the filtration membrane 20 is configured to separate struvite from a water stream. In another embodiment, the filtration membrane 20 is configured to separate vivianite from a water stream. In yet another embodiment, it is also contemplated that the filtration membrane 20 is configured for desalination of sea water, and may be used to separate salt from a water stream.

One of ordinary skill in the art will recognize that the following materials may be used to form the electrodes, including but not limited to carbon nanotubes, graphene, carbon paper, graphite, titanium, stainless steel, carbon nanotube- and graphene-based membrane composites. One of ordinary skill in the art will also recognize that the following materials may also be used to form the filtration membrane, including, but not limited to carbon nanotubes, graphene, ceramic, nanocellulose, membrane polymers embedded with electrically conductive elements.

A pipe descaling technology (PDT) may be used for phosphorus removal in multiple sizes of wastewater applications. The technology uses an induced electric field of variable amplitude and frequency that can promote precipitation of crystalline minerals (struvite) without the dangerous and damaging adhesion to pipes, pumps or in tanks. The PDT coupled with the electric filtration cell may be employed to enhance phosphorus capture.

Struvite (magnesium ammonium phosphate hexahydrate or MgNH₄PO₄.6H₂O) is a crystalline compound formed when magnesium ammonium phosphate ions are dissolved in a waste stream's liquid water phase above saturation concentrations. In many instances another compound containing phosphorus may also be present, vivianite or hydrated ferrous phosphate; Fe₃(PO₄)₂.8H₂O. Both of these compounds may be present in a wastewater treatment system's treatment processes and can lead to problematic scale formation on treatment plant surfaces clogging pipes, fouling valves and otherwise creating severe maintenance problems.

Struvite generation can also be employed to remove phosphorus from waste streams. There are several commercial-scale proprietary struvite generation systems on the market that are geared towards wastewater systems that are on a scale 10 times larger than applicable to smaller facilities such as farms, etc. This disclosure, in part, comprises the novel application of pipeline descaling technology (PDT) as a means of enhancing struvite generation and phosphorus removal in a cost-effective manner. Additionally, this disclosure, in part includes, innovative oscillating electric-field assisted membrane filtration means and technology useful to capture and recover struvite and/or vivianite from the stream exposed to PDT. Enhanced struvite generation and capture would improve the scalability of water resource recovery facilities. This disclosure is based, in part on the use of pipe descaling technology coupled with oscillating electric-field assisted membrane filtration for prevention of scaling, increasing the amount of particulate crystalline struvite and/or vivianite in suspension, and enhancing the recovery of these phosphorus containing minerals from wastewater streams.

### Process and Technology Applied

The Lake Champlain Phosphorus Total Maximum Daily Load (TMDL) has lowered phosphorus (P) discharge requirements on larger wastewater treatment and agricultural facilities. This stringent P control requirement necessitates the capture and removal of nearly all phosphorus present by additional process control means in order to achieve compliance. With conventional wastewater infrastructure currently in place, phosphorus is captured biologically or chemically and often released and recirculated through treatment processes by means of dewatering centrate (or filtrate), sludge storage decant and other forms of internal wastewater process recycle. Additional P is imported to facilities from waste generated outside of the facility service area. These wastes include but are not limited to septage, food process waste and brewers waste.

Phosphorus can be managed and exported from water resource recovery facilities and farms through the generation of and subsequent removal of struvite or vivianite. Often, wastewater facilities strive to control the chemical reaction that generates struvite/vivianite to prevent pipe clogging and other mechanical issues that crystalline scale can present. However, there are emerging technologies that form struvite and capture it as part of several proprietary processes. These full-scale commercial technologies are particularly effective in dealing with soluble phosphorus as it can be chemically manipulated to form a precipitate that is sold as a fertilizer component. Unfortunately, applications of these technologies have definite negative economies of scale constraints. Certain facilities may be a fraction of the size required to be cost effective for previous technologies.

Struvite and/or vivianite generation for control of these various process phosphorus sources using methods and systems of the present disclosure may increase wastewater treatment operational efficiencies, lower the amount of phosphorus recirculated throughout the treatment system and add to the benefit of more reliable final effluent compliance as well as lower P in treatment process residuals. The phosphorus removed may be captured in a phosphorus rich byproduct stream that may be a valuable resource for additional use. Embodiments of methods and systems of the present disclosure can be used for much needed P removal technology at a scale that is appropriate for multiple sizes of installations.

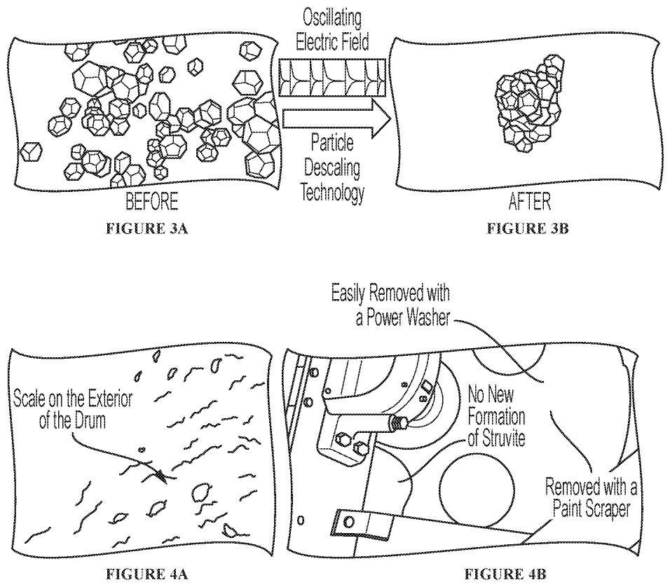

Certain embodiments of methods and systems of the present disclosure use an induced electric field of variable amplitude and frequency that can promote precipitation and stabilization of crystalline minerals in suspension that can be carried away with the flow without the dangerous and damaging adhesion to pipes, pumps or in tanks (FIG. 3). A 90-day test conducted by Tulsa Southside Wastewater Treatment Plant, Tulsa, Okla. revealed that the proposed pipe descaling technology may be used to release any heavy encrustation of struvite from the distribution pipes and Belt Filter Press (BFP) back into the stream, in addition to preventing any struvite build up in the systems (FIG. 4). Using this application for highly concentrated liquid waste may prove to safely remove phosphorus in many forms from waste that are treated.

PDT has been proven to be successful in controlling scaling on many technically important surfaces and systems. The PDT appears to produce P rich particles in the waste stream's liquid phase, and embodiments of the invention utilize filtration techniques to remove P by removing these crystalline solids by innovative filtration techniques. Thus, aspects of the present disclosure may combine the proven scale controlling PDT with an innovative oscillating electric-field assisted membrane filtration to potentially capture the PDT-induced stabilized minerals. Various forms of filtration can be utilized to capture and assess the struvite/vivianite generated and to ensure a viable product for removal and distribution as a resource.

Below herein are described two examples of filtration approaches that may be used in embodiments of the invention. A first approach (a) employs simple dead-end filtration to capture and recover PDT-stabilized minerals, and (b) assesses the reusability of the membranes for continued use. A second approach (a) employs oscillating electric-field cross flow membrane filtration to concentrate and recover PDT-stabilized minerals, and (b) assesses the reusability of the membranes. In all experiments, the nature of the minerals may be evaluated using scanning electron microscopy (SEM: visual crystal morphology and dry size) and X-ray diffraction (XRD: crystalline structure).

In an embodiment of the disclosure, the liquid fraction of anaerobically digested digestate (digester supernatant or dewatered centrate) is recirculated for precipitation and filtration of phosphorus in particulate crystalline form using the descaling technology. The remaining liquid stream is returned to the wastewater process at reduced P concentrations for further treatment.

### Approach 1—Combined PDT and Dead-End Membrane Filtration

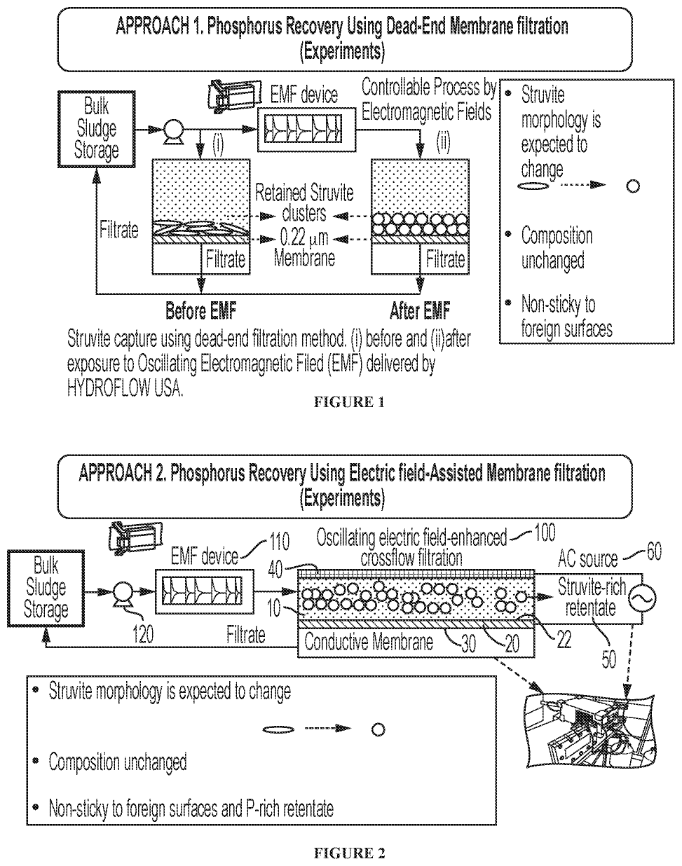

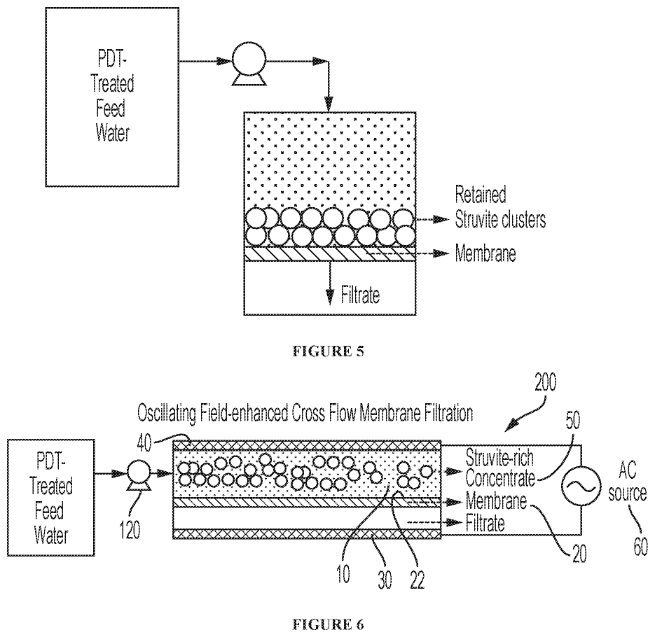

FIG. 1 illustrates a first approach to a water treatment system for recovering charged compositions, such as phosphorus. As illustrated, this system includes dead-end membrane filtration. The type of filtration employed to capture the PDT-induced crystalline minerals depends on the particle size distribution of the mineral clusters, which may be assessed using Dynamic Light Scattering (DLS) technique (Malvern Zetasizer ZSP). Knowledge of particle size distributions (hydrodynamic size) aids in the determination of an appropriate filtration technique (microfiltration (MF) or ultrafiltration (UF)) for capturing the particles in suspension. The MF and UF are well known for capturing particulates in water, however, they are also prone to fouling, i.e., particles deposited on the membrane surface block the membrane pores after a brief period of filtration, which decreases the separation efficiency and increases the cost of membrane filtration. Certain embodiments of PDT methods and systems of the invention alter the fundamental nature of the crystalline clusters making them much softer, non-sticky, and easier to wash off from the surfaces. In the membrane filtration experiments, accumulated crystalline clusters are washed off periodically with the filtrate water. Measurements are performed to determine appropriate filtration method and operating conditions are optimized for struvite and/or vivianite recovery, in addition to keeping the membranes from severe fouling. The results from these experiments result in efficient and enhanced capture of struvite and vivianite from the feed streams treated with PDT. FIG. 5 shows a schematic of an embodiment of the set-up in greater detail.

### Approach 2—Combined PDT and Oscillating Electric Field Cross Flow Membrane Filtration

FIG. 2 illustrates a second approach to a water treatment system for recovering charged compositions, such as phosphorous. As illustrated, this system includes electric field assisted membrane filtration. Studies are performed using a custom-built filtration unit, which in some embodiments is powered by a renewable energy source. The filtration unit is tested to assess its efficacy to capture and recover struvite and/or vivianite from PDT treated streams. In contrast to Approach 1 (Dead-End Filtration), the PDT treated stream is configured in a cross flow arrangement over a custom-designed portable filtration cell equipped with MF or UF membrane sandwiched between stainless steel electrodes. Each electrode serves as a cathode and an anode, and they can be activated with a low-frequency alternating current (AC) to deliver an oscillating-field across the membrane. In the oscillating-field the struvite and/or vivianite clusters also attain an oscillatory motion proportional to their surface electrical charge (zeta potential). Under cross flow conditions the oscillating clusters (particles) do not have sufficient time to deposit and form scale on the membrane surfaces, and thus can be carried away by virtue of the cross flow. This technique may be used to very efficiently concentrate and recover struvite and/or vivianite from PDT-treated streams, and it also keeps the membrane surface free of scale for a significant period of time. The surface charge (zeta potential) of the clusters are calculated from the electrophoretic mobilities (zeta potentials) of the clusters measured using Malvern Zetasizer ZSP. A conceptual schematic of the set-up is shown in FIG. 6.

Studies are performed that include processing an assortment of liquid waste streams including anaerobically digested sludge and low solids manure slurry liquid, in order to determine the potential effectiveness of this innovative application of this proven descaling device. In some experiments various coagulants and flocculants are added to evaluate their value in enhancing struvite filtration and removal from the waste stream being treated. The low energy descaling unit has an energy consumption equivalent to that of a 100 Watt light bulb and requires minimal space. Embodiments of methods and systems of the present disclosure may be used for wastewater treatment and by agricultural waste management facilities.

Embodiments of the invention include methods and systems to reduce the critical fouling problem in all membrane processes by developing and quantifying fouling control strategies involving electromagnetic fields and electrically-activated membrane systems. Key to the approach may be the use of techniques to manipulate the characteristics of foulants through the application of electromagnetic fields and electrical activation of the membranes. The fouling control methods and systems of the present disclosure can be used by various sectors that employ membranes.

The invention, in some aspects includes methods and systems with which to permit fouling control under the conditions of electromagnetic field-treated feed water and electrically activated conductive membrane in a cross flow filtration system. Experiments are performed to, for example: (i) characterize the effects of electromagnetic field on feed water composition including dissolved salts, organic molecules, bacteria, and viruses, which are precursors for scaling and biofouling during flow-mode conditions; (ii) quantify the effects of electromagnetic field-treated feed water composition on fouling in electrically activated cross flow membrane system; (iii) identify feed water components and membrane surface interaction mechanisms and operating conditions that lead to significant retardation of scaling and biofouling in electrically activated cross flow membrane system; and (iv) establish an optimization approach for scaling and biofouling control using flow-mode electromagnetic fields and electrically-activated cross flow membrane system under a wide range of feed water compositions. In preliminary studies, electromagnetic fields decreased substantial amount (˜90%) of struvite scaling on technical surfaces, changed sticky material into powder form, while oscillating electric fields alone decreased bovine serum albumin fouling and improved the permeate water flux by 30%.

Methods and systems of the invention may have a broad impact on every industry that uses membranes and pipes that carry water because they all are known to suffer from fouling, which degrades their long term performance and often increases their maintenance costs. Experiments are performed to determine a deeper understanding of the mechanisms that underlie the interactions of electromagnetic fields and foulants, and hence on electrically activated membrane performance. This knowledge is used to fundamentally alter the characteristics of water constituents in a beneficial way in terms of reducing the foulant accumulation on membrane elements and distribution pipes. The experimental results provide a comprehensive framework summarizing the role of various parameters necessary to optimize electromagnetic field-based fouling control strategies. This novel technology represents a sustainable (i.e. no chemical addition) solution that enhances the permeate water flux beyond previous conventional membrane cleaning and maintenance methods.

Aspects of the present disclosure are directed to a method of using a filtration membrane in a water treatment system to separate charged compositions from a water stream. The method includes the acts of providing a filtration membrane in a fluid passageway, flowing a fluid through the fluid passageway and through the filtration membrane, and generating an oscillating electromagnetic field across the filtration membrane to alter compositions in the fluid, such that the altered compositions remain on a first side of the filtration membrane. The method may further include the act of recovering the altered compositions from the first side of the filtration membrane. It is contemplated that the filtration membrane is configured as either a cross flow membrane or a dead end flow membrane. Furthermore, the filtration membrane may include at least one of a microfiltration membrane, an ultrafiltration membrane, a nanofiltration membrane, and a reverse osmosis membrane. The oscillating electromagnetic field may be configured to separate struvite, vivianite, and/or salt on a first side of the filtration membrane. The method may further include the act of generating an electromagnetic field within the passageway at a location upstream from the filtration membrane to pretreat the water stream prior to the filtration membrane to enable the charged compositions to precipitate out of solution.

Further aspects of the present disclosure are directed to a method of using a filtration membrane in a water treatment system to separate charged compositions from a water stream. The method includes the acts of providing a filtration membrane in a fluid passageway, flowing a fluid through the fluid passageway and through the filtration membrane, generating an electromagnetic field within the passageway at a location upstream from the filtration membrane to pretreat the water stream prior to the filtration membrane so that the charged compositions may precipitate out of solution, and generating an oscillating electromagnetic field across the filtration membrane to alter compositions in the fluid, such that the altered compositions remain on a first side of the filtration membrane. The method may further include recovering the altered compositions from the first side of the filtration membrane. It is contemplated that the filtration membrane is configured as either a cross flow membrane or a dead end flow membrane. Furthermore, the filtration membrane may include at least one of a microfiltration membrane, an ultrafiltration membrane, a nanofiltration membrane, and a reverse osmosis membrane. The oscillating electromagnetic field may be configured to separate struvite, vivianite, and/or salt on a first side of the filtration membrane.

### Exceeding the Limits of Membrane Processes Using Electromagnetic Fields: Optimizing Fouling Control

One of the most severe limitations in membrane water treatment processes is membrane fouling (Mallevialle et al. 1996, Wiesner and Chellam 1999). Fouling is an intrinsic property of feed water. It is common knowledge that fouling (by inorganic, organic, and biological constituents) causes deterioration of membrane material, water flux decline, increase in energy demand, increase in required chemical and physical cleaning frequency and consumption of chemicals, and hence higher water treatment costs. During water permeation, flux decline (fouling) occurs due to two phenomena: 1) concentration polarization (i.e., solute build up), which is a natural consequence of the selectivity of a membrane, and 2) fouling, which may include adsorption, pore blockage, deposition, and gel formation (Field 2010). The promise of membrane technology (i.e., the potential for dramatically improving the access to clean and drinkable waters, wastewater treatment with minimized waste discharge from treatment plants, and increasing the productivity of water desalination) may not be realized until a cost-effective and sustainable solution to mitigate membrane fouling is found. This membrane fouling problem, which is crucial for improving the sustainability and energy efficiency of membrane technology, is the focus of this disclosure.

Despite significant advances in understanding the fouling mechanisms and developing fouling mitigation strategies over the last decade, membrane fouling still remains an intractable problem that often cost industries billions of dollars in operation and maintenance each year (Hoek et al. 2008, Ruiz-Garcia and Ruiz-Saavedra 2015). It is well known that membrane fouling is influenced by factors such as feed water characteristics, membrane characteristics and module geometry, and operating conditions (Zhang et al. 2015). Several fouling (flux decline) control strategies have been proposed including, but not limited to, modification of feed water and membrane surface characteristics, optimization of operating parameters, hydraulic flushing, and electric field enhancement. These strategies can alleviate concentration polarization and membrane fouling to different degrees and affect different aspects of membrane systems. For example, (i) membrane modification using anti-bacterial nano-materials and polymers greatly enhances antifouling capacity, but has a short-term functionality; (ii) pretreatment and modification of feed water characteristics are very efficient, and have wide application and low cost, but these processes are highly complex and not easy to optimize; and (iii) hydrodynamic techniques can disrupt the accumulation and deposition of foulants, but the cost is high; and (iv) the applied sonic and electric field enhancement are emerging but may damage the membrane. After all these efforts, the fact that the fouling problem still plagues the membrane industry suggests that extensive research is critically needed to investigate underlying mechanisms and explore new ideas and techniques to enable more advanced control of flux decline (fouling) processes under wide range of water treatment applications.

The disclosure, in part, includes methods and systems comprising use of EMF to control fouling in membrane systems. Embodiments of the invention provide a novel strategy for membrane fouling control permit testing of the nature of the feed water, and its manipulation using electromagnetic fields (EMF), and passage through an electrically-activated membrane system. Studies utilizing these steps provide information on how EMF affects the types and degree of fouling in membranes, and thereby the conditions that can lead to enhanced permeate flux.

Studies are performed to assess strategies that include electromagnetic field-treated feed water (a novel in-line pretreatment strategy), oscillating electric field activated-conductive membranes (an emerging surface membrane modification strategy), and hydraulic flushing (conventional cleaning strategy), that provide required information on flux decline (fouling) mechanisms and control. Both EMF field for the feed water pretreatment and the oscillating electric fields (OEF) activated on the conductive membranes are powered by alternating current (AC) power source. FIG. 7 illustrates some embodiments of the strategy assessment experiments that are performed. In particular, FIG. 7 illustrates exemplary experimental research framework showing focus on testing and assessing the mechanisms of fouling control strategies using EMF and OEF on conductive membranes.

Previous studies and methods have addressed the membrane fouling challenge, particularly, the mechanisms and methods to minimize fouling using chemical and physical processes such as (i) anti-bacterial membrane surface modifications using nanoscale materials; (ii) suppression of the metabolic activity of the bacteria to reduce extracellular polymeric substances followed by membrane backwashing; and (iii) developed optimal fouling strategies to determine the time and duration for membrane regeneration by backwashing among others (Badireddy et al. 2008, Badireddy et al. 2013, Bagheri and Mirbagheri 2018, Cogan et al. 2016, Formoso et al. 2017, Li et al. 2017, Lin et al. 2010, Porcelli and Judd 2010, Sablani et al. 2001, Shannon et al. 2008, Shirazi et al. 2010, Zhang et al. 2016). In contrast, embodiments of methods and systems of the present disclosure include approaches to control scaling and biofouling using (i) an alternating current (AC) induced electromagnetic field (EMF) applied as a feedwater modification and/or (ii) an oscillating electric field (OEF) on an electrically-conductive membrane in pressure-driven membrane processes. Preliminary research has shown that such an approach is indeed feasible and promising (Badireddy 2016, Fojt et al. 2007, Gabrielyan et al. 2016, Gad and Jayaram 2014, Piyadasa et al. 2016, 2018, Tessaro et al. 2015, Torgomyan and Trchounian 2013, 2015). However, a clear mechanistic explanation of observed scaling and biofouling reduction phenomena is lacking. Some of the challenges encountered in the previous work include the lack of systematic evaluation of mechanisms and detailed quantitative information regarding key parameters such as nucleation induction, rate constants for scale and reactive oxygen species (ROS) formation among others, for reduction of scale and biofouling. Additionally, there are no works to date that have investigated the effects of coupling electromagnetic fields with electrically-conductive membranes on fouling in membrane processes. Embodiments of the invention are based in part on the first systematically and rigorously investigated scaling and biofouling mechanisms and their control using EMF and/or OEF to ensure that all the water quality benefits offered by membranes can be realized.

Embodiments of methods and systems of the invention are focused on two very relevant types of membranes that are commonly encountered in the water/wastewater and chemical industries: (i) ultrafiltration (UF) membranes and (ii) reverse osmosis (RO) membranes. The results of experiments using methods and systems of the invention provide better understanding of fouling mechanisms associated with emerging EMF-based fouling control methods and use of innovative membrane materials to achieve better membrane performance. These studies form the foundation for development of EMF-based methods to manipulate feed water characteristics, without needing to add pretreatment chemicals (e.g., anti-scalants and biocides), and to activate OEF on conductive membranes to control fouling over the membrane's lifetime. Both of these novel approaches transform the way water is treated, and enable realization of all the water quality benefits currently promised by advanced membrane technology.

Previous studies have been performed to evaluate scale mitigation strategies using an electromagnetic device developed in the inventor's laboratory. This device, including linked-ferromagnets wrapped by copper wire, can be latched to any circular pipe system. The diameter of the magnet can be increased or decreased by changing the number of links, and the strength and frequency of the field is varied by changing the number of loops on the magnet. This device, powered by 110V AC power outlet, delivers a 100 kHz electromagnetic field (EMF) into the pipe carrying waste effluent streams with the goal of mitigating scale formation in pipes and recovering valuable nutrients from wastewater. A 30-day evaluation of the EMF device revealed some interesting results related to scale formation. For example, the exposure to an oscillating electric field released scale from the surface of the Belt Filter Press back into the stream and no new scale deposits formed on the affected surface (FIG. 4). This is an exciting result because it makes possible concentration and controlled safe removal of the struvite and other minerals and removal of them safely without fouling the surfaces. Certain embodiments of the disclosure include use of EMF with membrane processes using electrically-conductive membranes. FIG. 4A illustrates the baseline condition of the Belt Filter Press (BFP) before applying proposed EMF (Left). FIG. 4B illustrates the condition of the BFP drum surface at the end of 30-day EMF exposure period (Right).

The research has four goals/sections directly related to the framework described in FIG. 4:

(1) Experiments are performed to: characterize the effects of electromagnetic field on feed water composition including dissolved salts, organic molecules, bacteria, and viruses, which are precursors for scaling and biofouling during flow-mode conditions.

(2) Experiments are performed to: quantify the effects of electromagnetic field-treated feed water composition on fouling in electrically-activated cross flow membrane system.

(3) Experiments are performed to identify feed water components and membrane surface interaction mechanisms and operating conditions that lead to significant retardation of scaling and biofouling in electrically-activated cross flow membrane system.

(4) Experiments are performed to establish an optimization approach for scaling and biofouling control using flow-mode electromagnetic fields and electrically-activated cross flow membrane system under a wide range of feed water compositions.

The following examples are provided to illustrate specific instances of the practice of the present invention and are not intended to limit the scope of the invention. As will be apparent to one of ordinary skill in the art, the present invention will find application in a variety of compositions and methods.

### EXAMPLES

Section 1—To characterize the effects of an electromagnetic field on feed water composition including dissolved salts, organic molecules, bacteria, and viruses, which are precursors for scaling and biofouling during flow-mode conditions studies are carried out that focus on molecular-level changes in feed water composition that occur during exposure to EMF. Application of EMF affects the particle nucleation, growth and precipitation of dissolved salts, and generates reactive oxygen species (ROS) that is detrimental to biological constituents in water. Additional studies are carried out to assess whether treatment with an EMF alters scale nucleation characteristics such as induction time, nucleation rate, rate of spontaneous precipitation, and crystal morphology, whether treatment with an EMF produce reactive oxygen species (ROS), which may oxidize the organic constituents and inactivate bacteria and viruses, and under which solution conditions and EMF range are the fouling potential of feed water increased or decreased.

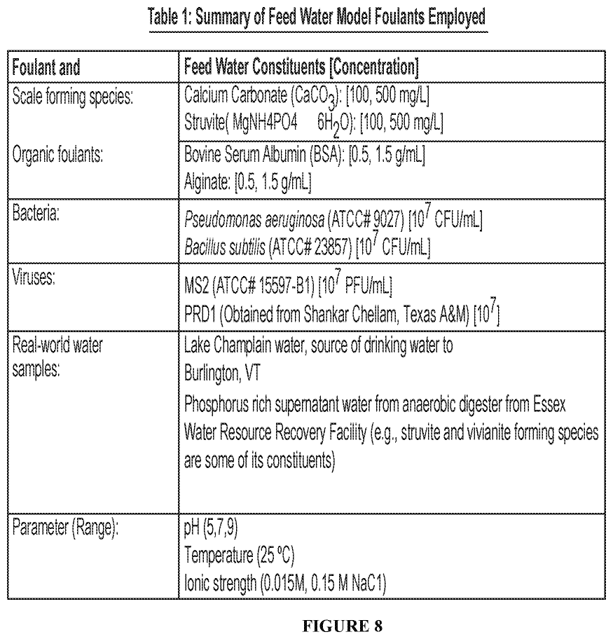

In the studies, model foulants, two real-world water samples, and experimental conditions are employed to assess the above factors. Foulants and constituents are summarized in Table 1, shown in FIG. 8. These model foulants are carefully chosen to represent the scale-forming dissolved ions, proteins, polysaccharides, bacteria, and viruses (bacterial viruses) that are common to both water and wastewater treatment systems. Bacterial viruses or bacteriophages are chosen to avoid the need for animal cell lines, biohazards to humans, animals, or the environment, difficulties in obtaining reliable and reproducible results. Feed waters to the pressure-driven membrane systems usually include components such as dissolved ions, organics, colloids, and particles. These components may interact with each other and affect fouling behavior (Gao et al. 2011). Experiments are carried out in a flow-mode apparatus that enables comparison to an identical feed water without applied EMF (FIG. 9).

A schematic of the flow-mode test apparatus is shown in FIG. 9. This apparatus consists of a custom-built electromagnetic field (EMF) device with a temperature-regulated conduit to carry the feed solution water containing various foulants, a pump, and a feed tank (a 2 L polypropylene container). Without any direct contact with the feed water, the EMF device induces a signal into the feed line at a desired output frequency (1 kHz, 20 kHz, and 100 kHz). The temperature regulated conduit equipped with the EMF device may be crucial for the experiments because changes in temperature could alter the nucleation characteristics of the scalants. The temperature of the flow system will be maintained at the temperature of the feed tank (FIG. 8—Table 1).

FIG. 9 illustrates an exemplary flow-mode apparatus fitted with an electromagnetic field (EMF) device. The flow path (i) shows feed water unexposed to the EMF field (control). In contrast, the flow path (ii) shows a feed water membrane surface which indicates that the foulants will undergo characteristic changes upon exposure to the EMF. For example, struvite precipitates may show needle-like (before exposure to the EMF) and sphere-like morphologies (after exposure to the EMF).

In each experiment, 1.8 L of freshly prepared feed water will flowed via peristaltic pump (36 mL/min) in order to generate a steady flow in the feed line fitted with the EMF device. The characteristics of individual foulants with and without exposure to the EMF are evaluated using the methods described below. The total time of treatment t_{T} is between 5 and 60 minutes. In this set up, the mean time of exposure of water to the EMF for n passes, is independent of the flow rate, Q: tₑₓₚ=πAL/Vt_{T}, where A is the cross-sectional area, L is the length of the feed line exposed to the EMF, and V is the total volume of the feed water. Specifically, the scaling and biofouling potential of the feed water constituents is investigated using experimentation and modeling as described below.

Scaling Experiments—The temperature of the feed water is maintained at 25° C. in a polypropylene container by water circulation through a constant temperature bath regulated by a thermostat. The stock solutions of magnesium chloride and dihydrogen ammonium phosphate are prepared from the corresponding crystalline solids MgCl₂.7H₂O and NH₄H₂PO₄ using ultrapure water. The stock solutions are filtered through membrane filters (0.22 μm, Millipore). The ionic strength of the solutions is adjusted by the addition of an appropriate amount of NaCl stock solution under stirring with a Teflon-coated magnetic stirring bar. A constant flow of nitrogen is maintained over the solution throughout the experiment to avoid atmospheric carbon dioxide intrusion. The pH and the minimization of the air volume above the solution ensure this condition. The feed tank is kept air-tight and the pH is adjusted to a desired value (Table 1 shown in FIG. 8) with a slow addition of 1N HCl or 1N NaOH. The transformation of scale-forming precursors going from the dissolved state to particle precipitation is controlled by the frequency of the EMF as shown in preliminary experiments (FIG. 10).

During the course of EMF treatment the samples are filtered through a membrane filter and the filtrates are analyzed for magnesium using inductively coupled plasma-optical emission spectroscopy (ICP-OES). The solid phase collected on the membrane is dried in a desiccator and characterized by powered X-ray diffraction (XRD), scanning election microscopy (SEM), energy dispersive spectroscopy (EDS), and Fourier transform infrared (FTIR) spectroscopy. In preliminary studies, SEM analysis of the struvite precipitates collected from control and EMF-exposed samples showed need-like and sphere-like morphologies, respectively (FIG. 10 (ii) and (iii)). This result suggests that the EMF treatment definitely alters the characteristics of struvite crystals.

The electrophoretic mobilities will be measured using Malvern ZetaSizer Nano ZSP. The driving force for the formation of struvite in an aqueous supersaturated solution is the difference between the chemical potentials, Δμ, of the salt in the supersaturated solution μₛ and from the corresponding value at equilibrium, μ_{∞}:

$$Δμ = {μ}_{\text{?}} - {μ}_{s} = kT ln \frac{{( {α}_{{Mg}^{2 +}} \text{?} {α}_{N \text{?} {H}_{4}^{+}} \text{?} {α}_{P \text{?} {D}_{4}^{3}} - )}_{s}^{\frac{1}{3}}}{{( {α}_{{Mg}^{2 +}} \text{?} {α}_{N \text{?} {H}_{4}^{+}} \text{?} {α}_{P \text{?} {D}_{4}^{3}} - )}_{∞}^{\frac{1}{3}}} = - \frac{kT}{\text{?}} ln S , \\ \text{?} \text{indicates text missing or illegible when filed}$$

where k is the Boltzmann's constant, T the absolute temperature, and S is the supersaturation ratio given by

$$S = \frac{{ }^{α} {Mg}^{2 + α} {{NH}_{4}^{+}}^{α} {PO}_{4}^{3 -}}{{K}_{s}^{0}}$$

where Kₛ⁰ is the thermodynamic solubility product of struvite (Profio et al. 2010). The relative supersaturation σ is defined as σ=S^{1/g}−1 (Anderson et al. 2013). The activities of the ionic species in solution is calculated by the ChemEQL v.2.0 code taking into account all chemical equilibria together with mass balance and electroneutrality conditions. The equilibria and the corresponding stability constants that are used for the calculations are obtained from the literature (Martell et al. 1998, Morel 1983, Ohlinger et al. 1998). The calculations are done by successive approximations for the ionic strength, l, while activity coefficients are calculated from the extended form of the Debye-Hückel equation proposed by Davies, i.e.,

$$- log {γ}_{z} = A {z}^{2} [ \frac{{I}^{1 / 2}}{1 + {I}^{1 / 2}} ] - 0.3 I ,$$

where A is the constant (0.509 at 25° C.) and γ_{z} the activity coefficient for the z-valent species. The pH is adjusted such that in the entire concentration range, the only phase that forms is the solid precipitate of struvite. The induction time preceding the onset of the crystallization is found to be inversely proportional to the solution supersaturation and is in the form given by

$$log {τ}_{ind} = log {A}_{sp} + \frac{B}{{( log s )}^{2}} ,$$

where Aₛₚ is constant and B is given by

$$B = \frac{β {υ}_{m}^{2} {γ}_{s}^{3}}{{( 2.303 kT )}^{3}} ,$$

where β is a shape factor (=32 for cubes), νₘ the molecular volume of struvite (=molecular weight/(Avogadro's number×Density×Number of ions in a formula unit)=7.99×10⁻²³ cm³). γₛ is the surface energy of the solid which is forming. Then a plot of log τ_{ind} versus (log S)⁻² will be used to determine the threshold between homogeneous and heterogenous precipitation. Furthermore, the rate of homogeneous nucleation, J, is related to the supersaturation ratio with equation

$$J = {A}^{′} exp ( - \frac{β {υ}_{m}^{2} {γ}_{s}^{3}}{{( k T )}^{3} {( ln s )}^{2}} )$$

where A′ is a pre-exponential factor (Anderson et al. 2013). Taking A′=10¹⁷ nuclei/cm³ and assuming that at the supersaturation (S*) in which the metastable state breaks down at a rate of J=1 nucleus/cm³ then it is possible to obtain a numerical value for γₛ from the nucleation rate equation. The rate of J=1 nucleus/cm³ corresponds to a supersaturation at which nucleation takes place within 1 min. The rate of spontaneous precipitation of struvite on the solution supersaturation may be expressed by power-law equations such as R=kₚσⁿ, where kₚ is a constant, σ is the relative supersaturation and n is the apparent order of the reaction. From the nature of the plot one can determine the mechanism of struvite crystal growth. The zeta potential measurements would reveal the nature of particle-particle interactions and particle stability in solutions treated with and without EMF. The above analysis is also carried out on CaCO₃ solutions and real-world water samples. The real-world water samples are analyzed to determine the extent of struvite and vivianite recovery as a result of EFM treatment. Crystal growth should reduce the concentration of ions, increase the size, and change the shape of the particles; thus particles can be easily captured and removed from the EMF-treated feedwater.

### Reactive Oxygen Species (ROS) Generation and its Effect on Biofoulants

The hypothesis is that the exposure to EMF generates ROS, which can modify foulants in ways that could potentially eliminate biofoulant fouling propensity in membrane processes. Experiments are carried out to assess the types of ROS formation and their impact on biofoulant properties. Control experiments include ROS scavenging probes that establish the presence of a particular type of ROS in the feedwater. Experiments are conducted at 25° C. and the generation of the four most important ROS (i.e., ¹O₂, .OH, O₂^{.-}, and H₂O₂) is assessed during the course of in-line EMF treatment of feed water. The feed water containing individual foulants (BSA, alginate, P. aeruginosa, B. subtilis, MS2, and PRD1) are passed through EMF and aliquots of the feedwater are withdrawn periodically to assess the impact of ROS on each foulant. Analysis of ROS and their impact on organic foulants, bacteria (10⁷ CFU/mL) and viruses (10⁷ PFU/mL) are assessed using the methods described below.

ROS Measurements: (i) Singlet oxygen (¹O₂) concentration is measured using the selective probe furfuryl alcohol (FFA) using [¹O₂]ₛₛ=k_{obs}^{FFA}/kᵣₓₙ^{FFA} where k_{obs}^{FFA} the first-order rate constant for FFA degradation, and kᵣₓₙ^{FFA}=1.0×108 M⁻¹s⁻¹. FFA is quantified with its peak absorption at 220 nm using Agilent 1100 high-performance liquid chromatography (HPLC) (Appiani et al. 2017, Badireddy et al. 2012); (ii) Hydroxyl radical (.OH) concentration is measured using probe compound potassium terephthalic acid (TPA), which forms hydroxyterephthalate (hTPA) upon reaction with .OH. The hTPA is quantified with its peak absorption at 315 nm using Agilent 1100 high-performance liquid chromatography (HPLC)(Janssen et al. 2015, Page et al. 2010); (iii) Superoxide radical anion (O₂^{.-}) concentration is measured using probe compound 2,3-Bis-(2-methoxy-4-nitro-5-sulfophenyl)-2H-tetrazolium-5-carboxanilide (XTT), which forms XTT-formazan upon reaction with the radical. The formation of the XTT-formazan is determined via absorption at 270 nm using a SpectraMax UV-vis spectrophotometer (Badireddy et al. 2007, Erdim et al. 2014); (iv) Hydrogen peroxide (H₂O₂) concentration is measured using the probe compound Ampliflu Red, which forms resorufin in the presence of horseradish peroxidase. H₂O₂ standard solution is used to calibrate the resorufin peak area in relation to H₂O₂ concentration. The formation of the resorufin is quantified via absorbance at 560 nm using Agilent 1100 high-performance liquid chromatography (HPLC)(Chu et al. 2016, Zhou et al. 1997).
Viability and Oxidation Assays: (i) Bacteria are cultured and enumerated using commonly used protocols. For example, the cell viability, before and after exposure to EMF, are determined using live/dead fluorescent staining assay (Live/Dead BacLight Bacterial Viability kit) and spread plate technique (CFU/mL) as reported in the literature (Kang et al. 2008, Pasquini et al. 2012, Perreault et al. 2015). Changes in the cell morphology are evaluated using SEM; (ii) Bacterial viruses (bacteriophages) are cultured and enumerated using commonly used protocols such as the double-agar layer method (PFU/mL). The changes in the virus morphology are evaluated using TEM. The oxidation of capsid proteins are assessed using carbonyl assay and FTIR (Badireddy et al. 2012); (iii) BSA and alginate are analyzed using a commonly used carbonyl assay for oxidation. BSA concentration is measured using the BCA protein assay (from Pierce) and alginate concentration is measured by Dubois using a phenol-sulfuric acid method (Saha and Brewer 1994). The structural changes are assessed using FTIR (Badireddy et al. 2010, Badireddy et al. 2008b).

The above experiments provide insight into the molecular-level alterations that may occur in the feed water during the course of exposure to the EMF. It is likely that these alterations may lead to a dramatic reduction of fouling in membrane systems.

Section 2—Quantify the effects of electromagnetic field-treated feedwater composition on fouling in electrically-activated cross flow membrane system.

Here, the focus is on effects of EMF-pretreated feedwater composition and oscillating electric field (OEF)-activated cross flow membrane system on fouling control. The aspects to assess include: (1) How changes in feed water composition with/without EMF pretreatment affect membrane permeate flux decline (fouling); and (2) How the activation of oscillating electric fields on the membrane surface synergistically work with electromagnetically modified feed water to reduce scaling and biofouling.

Studies are performed based on the results from Section 1, using feedwater constituents (foulants) pretreated with and without EMF studies to quantify permeate flux recovery compared to control (no EMF, no OEF) in OEF-activated cross flow membrane system.

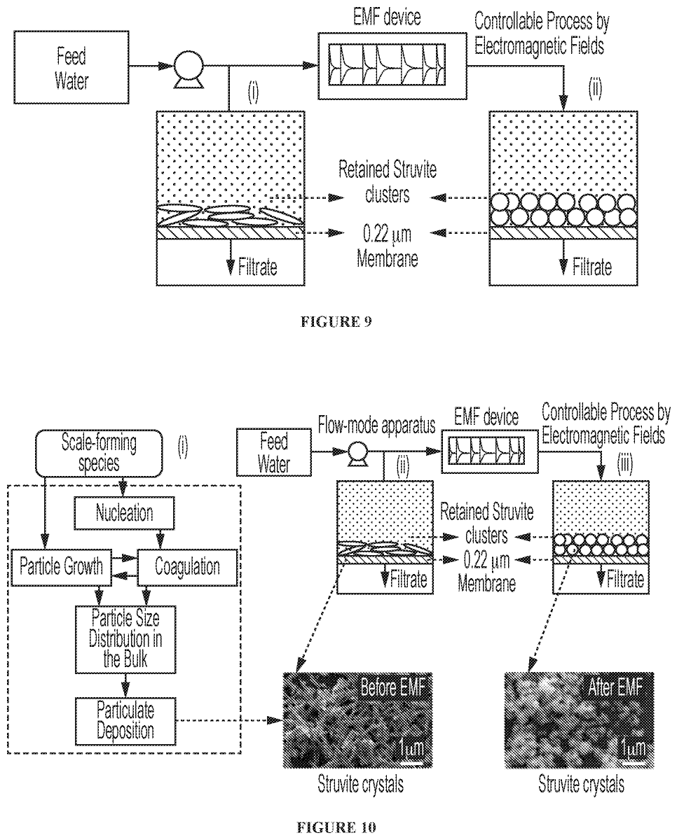

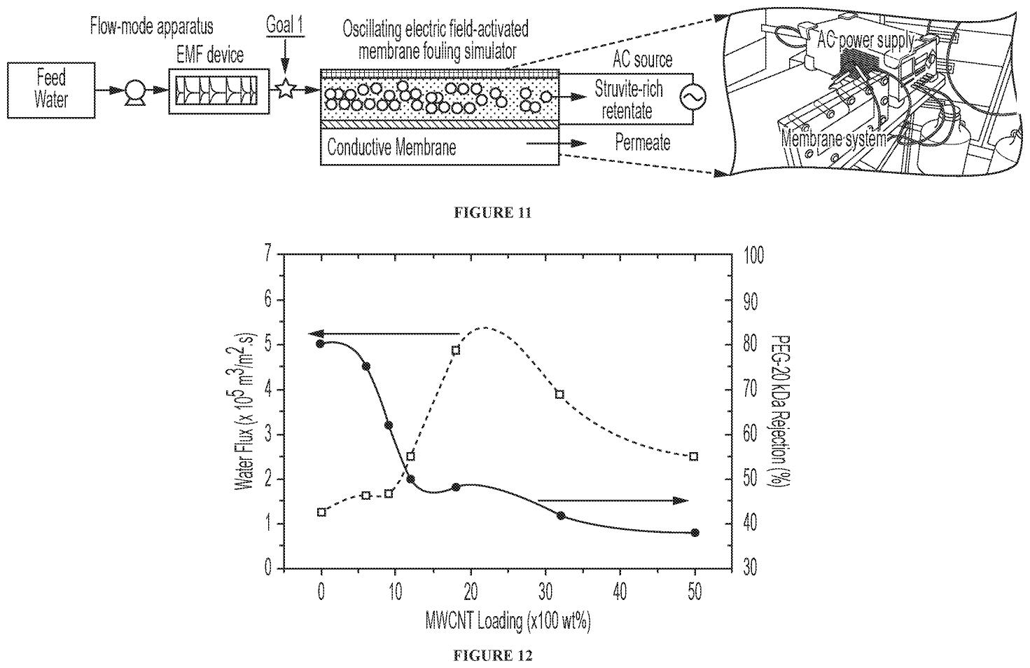

Although this investigation can be extended to MF, UF, NF, RO, and FO processes, UF and RO processes are employed only to quantify the extent of scaling and biofouling of feedwater exposed to in-line EMF. The electrical activation of the UF and RO membranes is achieved by membrane material modification with carboxyl-functionalized multi-walled carbon nanotubes (MWCNTs). MWCNTs are known for their extraordinary electrical conductivity and mechanical strength, and thus they are used as both electrodes and membrane elements, which deliver fields into the bulk flow and separate permeate water. FIG. 11 illustrates a schematic of the flow-mode apparatus (feed line) equipped with EMF device connected to a membrane fouling simulator.

The discharge from the flow-mode apparatus is configured to flow tangentially on the UF or RO membrane in the rectangular OEF-activated membrane fouling simulator. The simulator consists of a thin rectangular channel of 37 cm length and 3.6 cm width. The channel height is 6.5 mm. The anode is a graphite paper (length 33.5 cm, width 3.4 cm, thickness 1 mm). The cathode is the MWCNT/UF or MWCNT/RO mounted parallel to the flow path of the UF or RO channel. The membrane is supported by a porous honeycomb polycarbonate structure. The MWCNT/UF and MWCNT/RO are routinely synthesized and characterized in the laboratory. A phase-inversion method is used to synthesize MWCNT/UF membranes. This involves casting a degassed solution composed of polysulfone (PSF:18 wt %), dimethylformamide (DMF: 82 wt %), and 5-isocyanato-isophthalolyl chloride MWCNTs (ICIC-MWCNT: 0.22 wt %). The effect of MWCNT-loading in MWCNT/UF or MWCNT/RO membranes on water flux and foulant rejection (polyethylene glycol (PEG 20 kDa) is shown in FIG. 12.

The 0.22 wt % MWCNT/PSF is employed for all UF experiments. RO experiments use high performance (high water flux and salt rejection) MWCNT/polyamide RO membranes synthesized using the Kim H. J. method (Kim et al. 2014). Both UF and RO are subjected to the operating conditions described in Table 2 (shown in FIG. 13). The membranes are compacted at a pressure higher than the maximum operating pressure using distilled water. During the experiment, permeate samples are withdrawn periodically for characterization and analysis. The effect of operating conditions such as pressure, cross flow velocity, electric field, and foulant type and concentration are investigated (Table 2 and FIG. 13). For better understanding of fouling in the UF/RO systems the permeate flux and foulant membrane surface concentration are determined using fundamental mass transport models modified to include the effect of OEF on permeate flux. The permeate flux is modeled by the phenomenological equation, v_{w}=Lₚ(ΔP−σΔπ) where Δπ=πₘ−πₚ and σ is the osmotic reflection coefficient (Bowen and Jenner 1995, Bowen and Williams 1996, Bowen et al. 2001, Enevoldsen et al. 2007). A steady state solute mass balance within the viscous mass transfer boundary layer in the rectangular channel (Hunter 1981) and the expression of Sherwood number (Sh) developed for turbulent flow regime will be used to estimate the mass transfer coefficient (Bird et al. 2002).

This expression coupled with osmotic pressure governed by membrane permeation in the presence of electric field in a rectangular channel model is used for predicting permeate flux and membrane surface concentration and (Huotari et al. 1999, Jonsson and Macedonio 2010, Lutz 2010, Masliyah and Bhattacharjee 2006). The estimation of membrane surface concentration is required for better understanding of concentration polarization. The permeate flux is a strong function of membrane surface concentration, which is a function of the feed composition, hydrodynamic conditions, electric field strength, etc., In a preliminary analysis, at a transmembrane pressure of 350 kPa and Reynolds number (Re) of 5590, the model predictions of permeate flux and BSA membrane surface concentration profiles as a function of applied electric field strength are shown in FIG. 14. This results clearly indicates significant improvement of permeate flux and decrease of concentration polarization from BSA fouling in the presence of electric field during UF. Experimental data from experiments is modeled using the above approach. The foulants are characterized and analyzed using the methods as described above in Section 1. After completion of an experiment, the membrane is hydraulically forward flushed in situ thoroughly for a predetermined period by re-circulating ultrapure water (or permeate water) at room temperature.

### Quantifying Heterogeneous Scaling

A resistance-in-series model modified with the concentration polarization theory and crystallization kinetics is used to understand fouling due to scale formation over a range of conditions (Table 2 shown in FIG. 13). The permeate flux can be estimated using the surface blockage and cake filtration models

$${v}_{w} = {L}_{p} ( Δ P - Δπ ) = \frac{Δ P - Δπ}{μ ( {R}_{m} + {R}_{c} )} \times \frac{A - {A}_{b}}{A}$$

where μ, the permeate viscosity, Rₘ is the membrane resistance, R_{c} is the resistance due to cake formation, A is the membrane area,

$${A}_{b} ( = \frac{β {m}_{s}}{A} )$$

is the membrane area occupied by surface crystals, β is the area occupied per unit mass, and mₛ is the mass of scale formed directly on the membrane surface. Assuming that the crystal slurry is incompressible,

$${R}_{c} = \frac{α {m}_{s}}{A}$$

where α is the specific cake resistance and mₛ is the accumulated mass of precipitated scale. The induction time prior to the onset of heterogeneous nucleation can be evaluated using the approach described in Section 1. The rate of heterogeneous nucleation on the membrane surface can be estimated by

$$\frac{d {m}_{s}}{d t} = {k}_{s} ( A - {A}_{b} ) {( {c}_{n} - {c}_{s} )}^{n}$$

where kₛ is the rate of surface crystallization, cₛ is the saturation concentration, n is the order of reaction rate. Furthermore, assuming that bulk crystallization occurs on the surface of suspended crystal particles, the mass of cake crystals can be expressed as

$$\frac{d {m}_{c}}{d t} = {{k}_{b} ( {c}_{b} - {c}_{o} )}^{m}$$

where k_{b} is the apparent rate constant of bulk crystallization. The major difference between

$$\frac{d {m}_{s}}{d t} and \frac{d {m}_{c}}{d t}$$

is the type of driving force for the crystallization. After evaluating of fouling potential of EMF-modified feedwater in UF and RO systems, fouling conditions and foulants may be further investigated to understand the fouling mechanisms.
Section 3—Identify feedwater components and membrane surface interaction mechanisms and operating conditions that lead to significant retardation of scaling and biofouling in electrically-activated cross flow membrane system.

Fouling rate in a membrane process is dependent on two factors, namely the permeate flux (v_{w}) and the fouling potential of the feedwater (Results from Section 2). The permeate flux is affected by the membrane resistance and the driving pressure (ΔP), while the fouling potential is an intrinsic property of the feedwater. Studies are performed using a normalization method that should be able to separate the contributions of the water properties to the fouling rate from those operational properties (Song et al. 2004). This can be done with a proper definition of the fouling potential of the feedwater

$$( {R}_{t} = {R}_{0} + {k}_{p} {\int }_{0}^{t} {v}_{w} ( t ) d t ) or ( {k}_{p} = \frac{{R}_{t} - {R}_{0}}{{V}_{t}} = - ( \frac{Δ P}{{v}_{w}^{3}} ) \frac{d {v}_{w}}{d t} ) and {f}_{N}$$

the normalization descripto

$$( {f}_{N} = \frac{{v}_{w}^{3}}{Δ P} ( or \frac{Δ {P}^{2}}{{R}_{t}^{3 ) )}} .$$

R_{T} is the total membrane resistance at time t, R₀ is the clean membrane resistance, and kₚ is the fouling potential of feedwater. The advantage of this approach is that it relates the fouling potential of feedwater directly to the permeate flux decline rate. This in turn leads to the well-known cake filtration model for the time dependent flux and is given by

$${v}_{w} = \frac{Δ P}{{( {R}_{0}^{2} + 2 k Δ P t )}^{1 / 2}} .$$

Pore blockage and cake formation are considered two essential mechanisms for membrane fouling, in addition to the development of a concentration polarization layer on the membrane surface. However, evaluation based on measurements of permeate flux may not be reliable because a good water flux does not necessarily assure a good operational flux (Arnal et al. 2011). Even when the permeate flux is fully restored after membrane cleaning, it may drop immediately after a new filtration cycle resumes (Tay and Song 2005). Nevertheless, flux recovery is a good indicator for cleaning effectiveness due to the quick, non-invasive, and simple nature of this metric. Moreover, a comprehensive evaluation of the oscillating electric fields and hydraulic forward flushing performance needs not only provides the immediate result represented by flux recovery, but also provides information on the effect of the fouling control strategy on intrinsic membrane properties and fouling reduction over long time. Therefore, the more sophisticated way of studying the fouling control performance is membrane autopsy with different material characterization techniques. Although this approach is destructive, complicated and often expensive, one may use the membrane autopsy approach to generate necessary information relating to the membrane and fouling residuals, which in turn provide more insights into the efficiency of fouling control over the wide range of experimental operating conditions including EMF, OEF, and/or hydraulic flushing.
Membrane Autopsy. The membrane before and after fouling simulations is comprehensively characterized to gain insights into the fouling control efficiency of EMF and oscillating electric field with periodic hydraulic flushing. Membrane surface charge and functional groups are determined using streaming potential (Malvern ZetaSizer Nano ZSP) and XPS, respectively. The surface is highly dependent on the interactions between the membrane and foulants. Therefore, it may be important to assess the efficiency of fouling control. The hydrophilicity of a membrane surface is determined by measuring contact angles using the Theta Lite Optical Tensiometer. The hydrophilicity plays a critical role in scaling and biofouling propensities of membrane processes. FTIR in conjunction with attenuated total reflectance (ATR) may be used to analyze surface chemical composition and functional groups. SEM-EDS is used to determine mineral foulants on the membrane surface. SEM is used to visualize scale- and biofouling-forming species depositions on the membrane surface. Confocal laser scanning microscopy (CLSM) is used to produce 3D images of foulants labeled with fluorophores. AFM is used to measure the adhesion forces between the foulants and the membrane surface, in addition to mapping spatially resolved 3D surface topography. Electrochemical impedance spectroscopy (EIS) is used to characterize the foulants on the conductive membranes.
Section 4—Studies are done to establish an optimization approach for scaling and biofouling control using in-line electromagnetic fields and electrical-activation of conductive membranes under a wide range of feedwater compositions. To exceed the current limits of membrane processes, i.e., enhance the permeate water flux from what is currently achieved in membrane processes, experiments are done using the following approach to optimize fouling control strategy including feedwater modification (e.g., EMF), membrane modification (e.g., conductive membranes), and operating conditions and design (e.g., hydraulic flushing and OEF). Studies are also done to examine all conditions that produce characteristic changes in feedwater composition during flow-mode EMF operation that can lead to reduced foulant accumulation on the membrane surface in electrically-activated cross flow membrane system. Specifically, treatment time and frequency of electromagnetic field are correlated with the characteristic changes to identify the critical EMF that produce feedwater composition with lower fouling potential. Furthermore, the foulants with characteristic changes are applied to UF and RO processes to evaluate the scaling and biofouling control. While keeping the membrane structure and chemical composition constant, the flux decline phenomenon is evaluated in terms of mass transport parameters, and relationships between permeate flux and foulant concentrations on the membrane surface are determined as function of applied OEF. The rate of scaling and biofouling formation is evaluated for each set of operating conditions (Table 2). The operating parameters such as cross flow velocity, driving pressure, electric field and frequency, and pH at constant temperature are varied in order to determine optimum conditions that result in enhanced permeate flux. Furthermore, the periodic hydraulic flushing is employed to remove the fouling residuals. The flushing time and frequency is optimized. Additionally, the OEF is varied for each set of operating conditions to determine the critical field strength at which no further improvement in permeate flux is observed. The critical field is defined as the electric field at which the net particle migration towards the membrane surface is zero. The critical electric field is given by

$${E}_{cr} = \frac{{\overline{v}}_{w max}}{{u}_{ϵ}}$$

where v̅_{w max} is the maximum flux obtained at a transmembrane pressure and cross flow velocity. uₑ is the electrophoretic mobility which can be expressed by using Helmholtz-Smoulochowski's equation (Hunter 1981). The combined data from feedwater composition modification (Section 1) and flux control strategies and mechanisms (Section 2 and 3) may be closely analyzed for potential synergistic effects from combining flow-mode EMF with OEF-activation in cross flow membrane systems that lead to optimized fouling conditions, thus enhanced permeate flux. Evidence of synergistic effects can fundamentally alter the performance of membrane technologies, in terms of reduced cost of operation and enhanced water production from a wide variety of water sources, and possibly ushering in a new era of electromagnetic field-based fouling control strategies.

This disclosure forms a foundation for future development of EMF-based methods to manipulate feedwater characteristics, without needing to add pretreatment chemicals (e.g., anti-scalants and biocides), and to activate OEF on conductive membranes to control fouling over the membrane's lifetime. Success with both of these novel approaches will transform the way water is currently treated, and thereby enable realization of all the water quality benefits currently promised by advanced membrane technology.

### Experiment 1

The centrate water sample was composed of magnesium (21 mg/L), ammonia (990 mg/L), and phosphorus (130 mg/L, dissolved), which are commonly known as MAP or struvite-forming constituents. In addition, 48 mg/L calcium and 7.1 mg/L iron were also present. The pH of the centrate water was 7.54 at 22.7° C.

First, 20 mL centrate samples were centrifuged at 10,000 rpm for 30 minutes to remove suspended solids. The supernatant was then decanted and filtered using a 5 μm polycarbonate membrane filter (Millipore Sigma, USA) to obtain a sample free of suspended solids. Finally, the filtered supernatant was treated for 1 hour and 4 hours with 150 kHz oscillating electric field delivered by PDT. The PDT device with centrate water sample is taped inside the ferrite rings. The supernatant sample that was not exposed to the electric signal served as a control. After 1 hour and 4 hours of exposure to the electric signal, samples were immediately filtered using 5 μm polycarbonate filter (Millipore Sigma, USA) to retain the electric field-induced struvite and other crystallites on the filter surface. The filter with retained crystallites (or solids) was air dried and analyzed for chemical composition by using scanning electron microscopy (SEM) and energy dispersive X-ray spectroscopy (EDS). The crystals generated with and without electromotive force (EMF) were also analyzed by using X-ray fluorescence (XRF) spectrometer. The SEM was used to determine the crystal morphology, EDS was used to determine the composition of crystallites, and XRF was used to measure the composition of the settled solids. The analyses were conducted on both the control and the electric field treated samples. The filtered samples were also analyzed for ammonium (24 hour exposure) and ortho-phosphate (1 hour, 4 hour and 24 hour exposure) by EPA method 350.1 and 365.5 respectively.

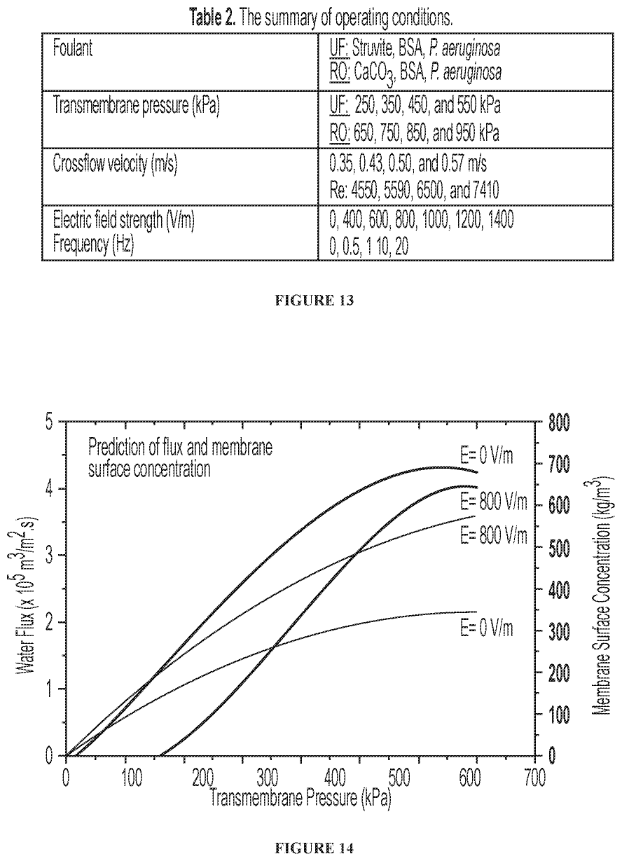

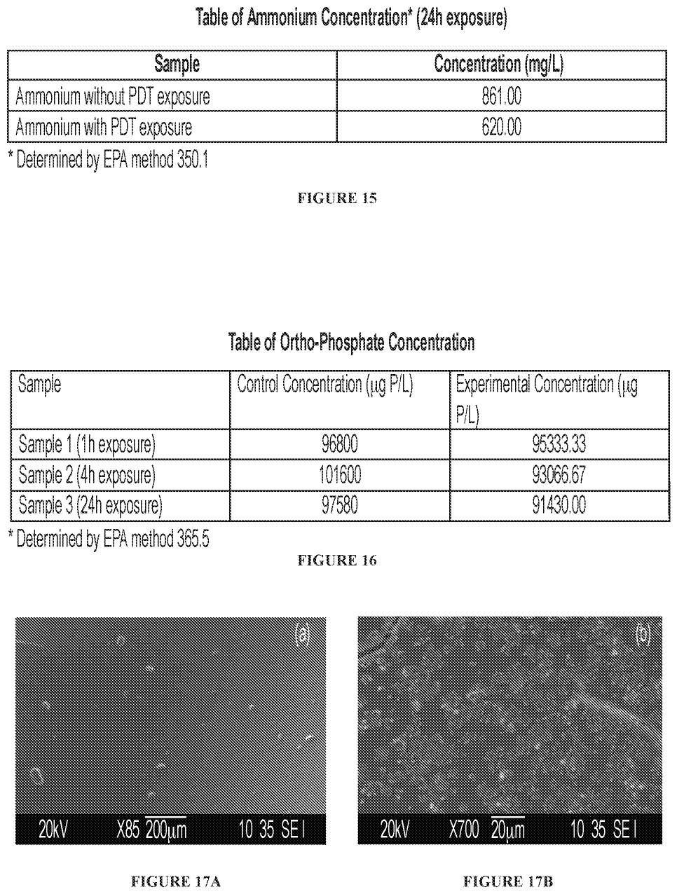

Results—Supernatant Analysis—After the experiment, all samples were filtered with 5 μm polycarbonate membrane filter (Millipore Sigma, USA), and analyzed for ammonium (24 hours exposure) and ortho-phosphate (1 hour, 4 hour and 24 hour exposure). The results are given in the tables shown in FIGS. 15 and 16. The results indicate that after exposure to PDT, phosphorus content in the wastewater is decreasing. This decrease in phosphorus concentration in wastewater is directly related to struvite crystal formation due to exposure of PDT.

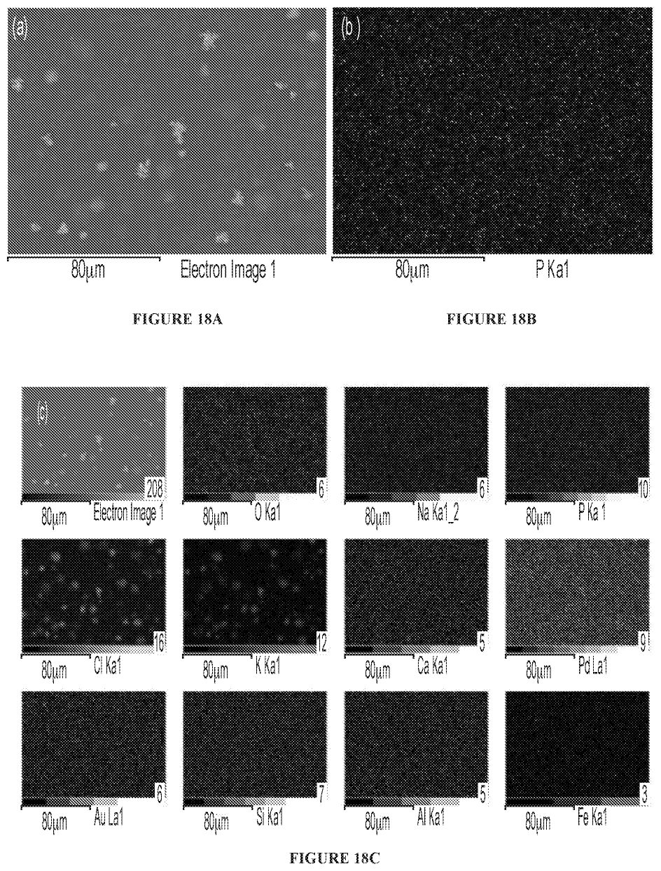

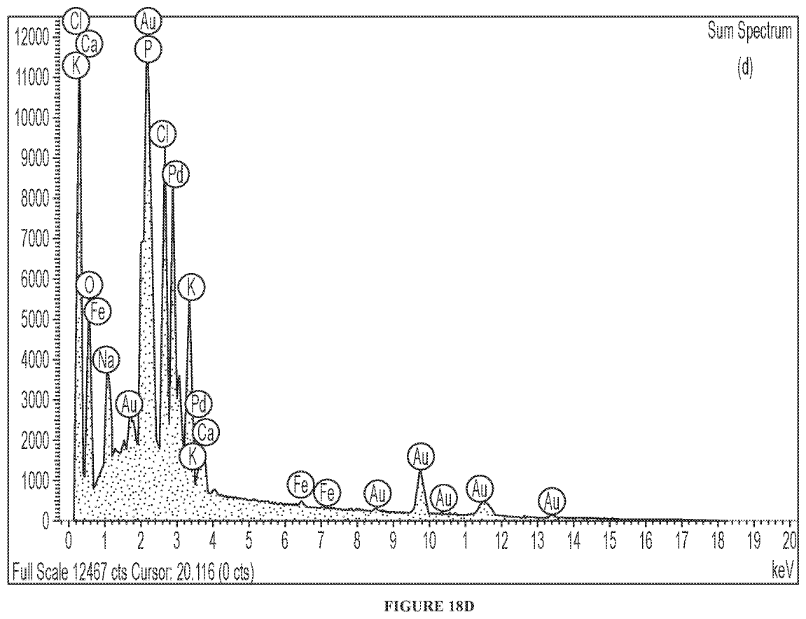

Crystal Analysis—Scanning Electron Microscope (SEM) and Energy Dispersive X-ray Spectroscopy (EDS) (JEOL JSM 6060)—After exposure to PDT supernatant samples were filtered using 5 μm filter. High-resolution scanning electron microscopy images of the sample on the membrane filter are shown in FIGS. 17A and 17B and FIGS. 20A and 20B. EDS reports are shown in FIGS. 18A-18D, FIGS. 19A-19D, FIGS. 21A-21D and FIGS. 22A-22D.

FIGS. 17A-17B illustrate Scanning Electron microscope images. FIG. 17A illustrates a 1 hour control sample (without PDT exposure) and FIG. 17B illustrates a 1 hour experiment sample (exposed to PDT). FIGS. 17A and 17B illustrate the distribution of crystals under SEM. From the SEM images of both the control and the treatment sample it is observed that there are only a few struvite crystals (Orthorhombic pyramidal crystals) [Prywer J. et al., Crystal; 2019; 9(2); 89, and Prywer J. et al.; Urol. Res. 2012; 40(6); 699-707] in the control sample, however, in the treatment sample a rich presence of platey-mica like struvite is found [Prywer J. et al., Crystal; 2019; 9(2); 89, and Prywer J. et al.; Urol. Res. 2012; 40(6); 699-707].

FIGS. 18A-18D illustrate the energy dispersive X-ray spectroscopy of a 1 h control sample. FIG. 18A illustrates an electron image. FIG. 18B illustrates surface mapping of Phosphorous (P) distribution, FIG. 18C illustrates Elemental mapping, and FIG. 18D illustrates the Spectrum of elemental composition. All the images of EDS were processed using Aztec Inca® Software (Oxford Instrument).

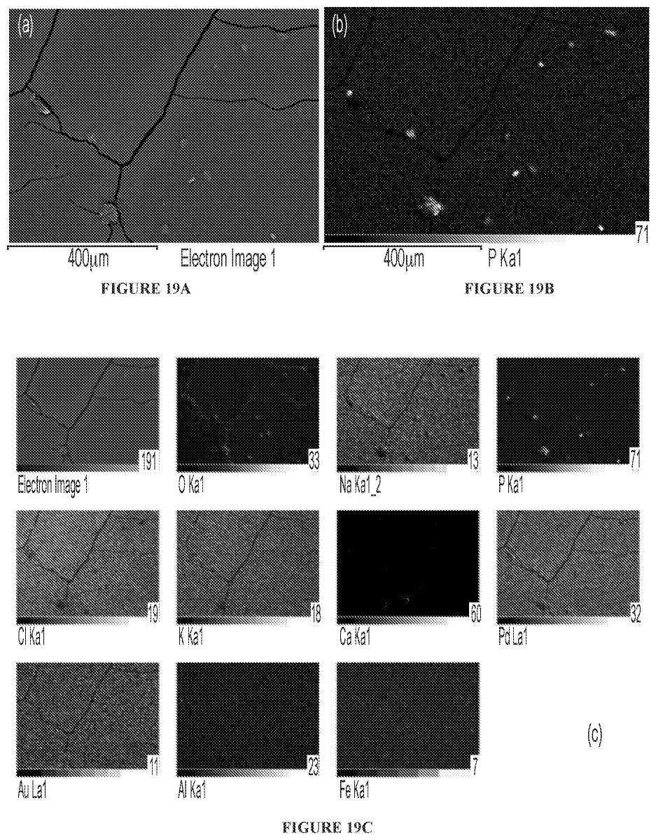

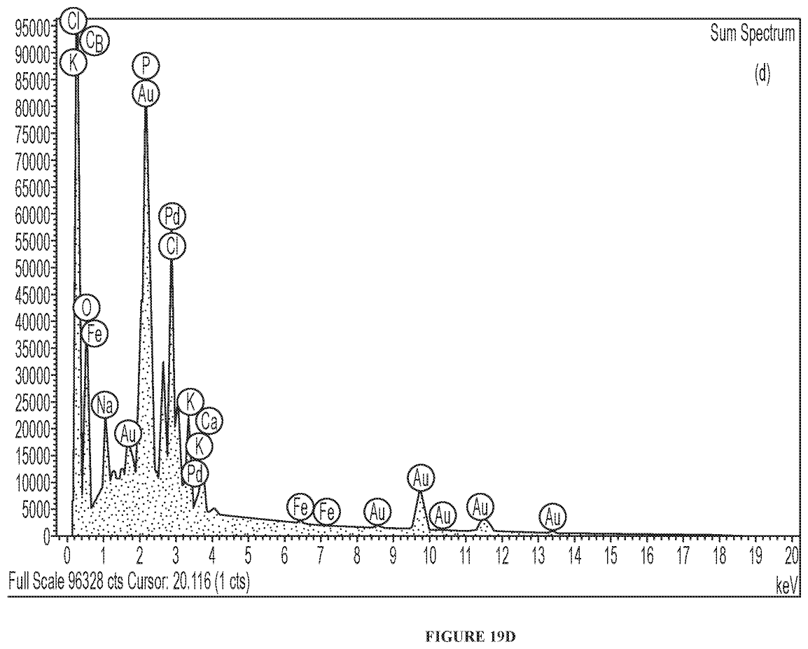

FIGS. 19A-19D illustrate the energy dispersive X-ray spectroscopy of a 1 hour experiment sample. In particular, FIG. 19A illustrates an electron image, FIG. 19B illustrates the surface mapping of Phosphorous (P) distribution, FIG. 19C illustrates Elemental mapping, and FIG. 19D illustrates the Spectrum of elemental composition.

FIGS. 18A-18D and 19A-19D are the EDS reports of a 1 hour blank and experiment samples respectively. The reports include the chemical composition of the crystal, elemental mapping and spectrum of elemental composition. Comparing between the elemental map shown in FIGS. 18B and 19B shows that there is a substantial increase in phosphorus concentration in the EMF treated sample. Another observation is that the phosphorus in the blank (control) is widely spread out in the surface of the membrane. However, after exposing the sample in an electrical field it grows into crystal in a more localized form. The spectrum of elemental composition also shows that the EDS had identified phosphorus only around 11,500 times in the 1 hour control sample. In contrast, the EDS detected phosphorus over 85,000 times in the EMF exposed sample. FIGS. 19A and 19C, and FIGS. 20A and 20C are the electron microscope images of the examined surface and the entire elemental mapping for control and treated sample.

FIGS. 20A and 20B illustrate Scanning Electron microscope images. In particular, FIG. 20A illustrates a 4 hour control sample (without PDT exposure) and FIG. 20B illustrates a 4 hour experiment sample (exposed to PDT).

FIGS. 20A and 20B illustrate the distribution of crystals that are formed in both the control and an EMF treated sample after 4 hours. After exposing the sample wastewater to EMF for 4 hours, crystals forms in the shape of platey-mica which confirms the presence of struvite [Prywer J. et al., Crystal; 2019; 9(2); 89, and Prywer J. et al.; Urol. Res. 2012; 40(6); 699-707]. The crystals showed in FIG. 20B are mostly an agglomeration of numerous crystallites.

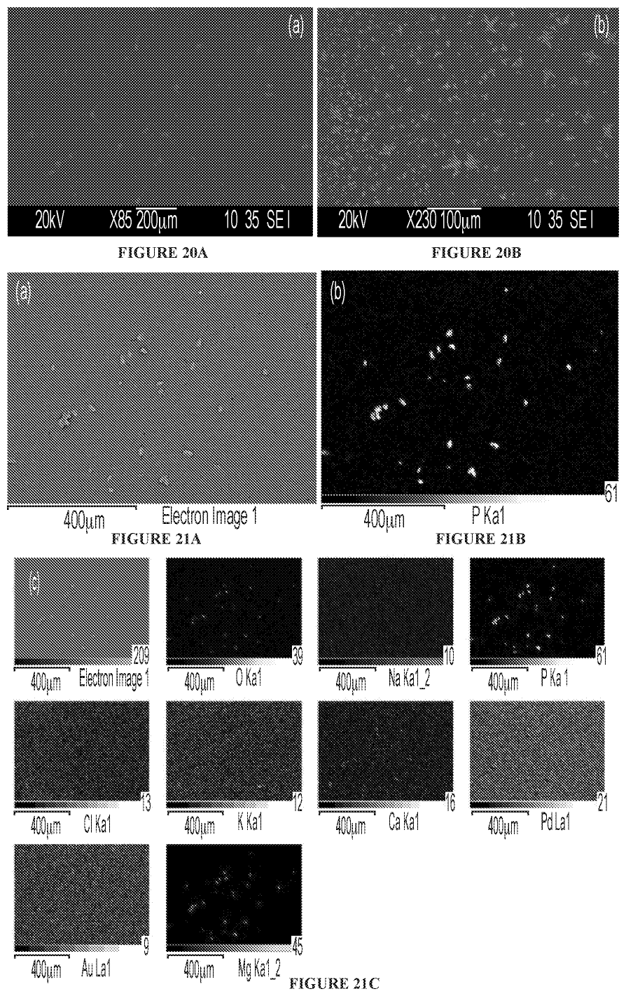

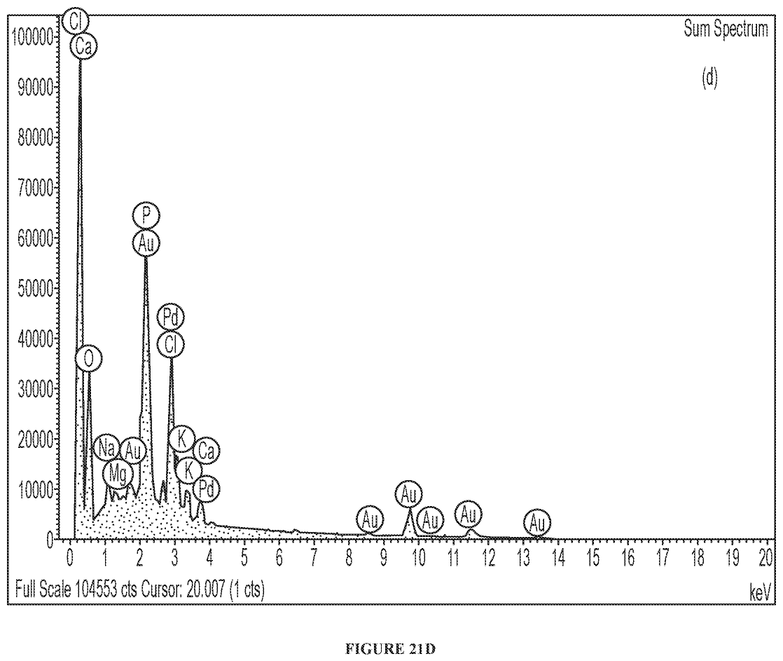

FIGS. 21A-21D illustrate the energy dispersive X-ray spectroscopy of a 4 hour control sample. In particular, FIG. 21A illustrates an electron image, FIG. 21B illustrates surface mapping of Phosphorous (P) distribution, FIG. 21C illustrates elemental mapping, and FIG. 21D illustrates the spectrum of elemental composition.

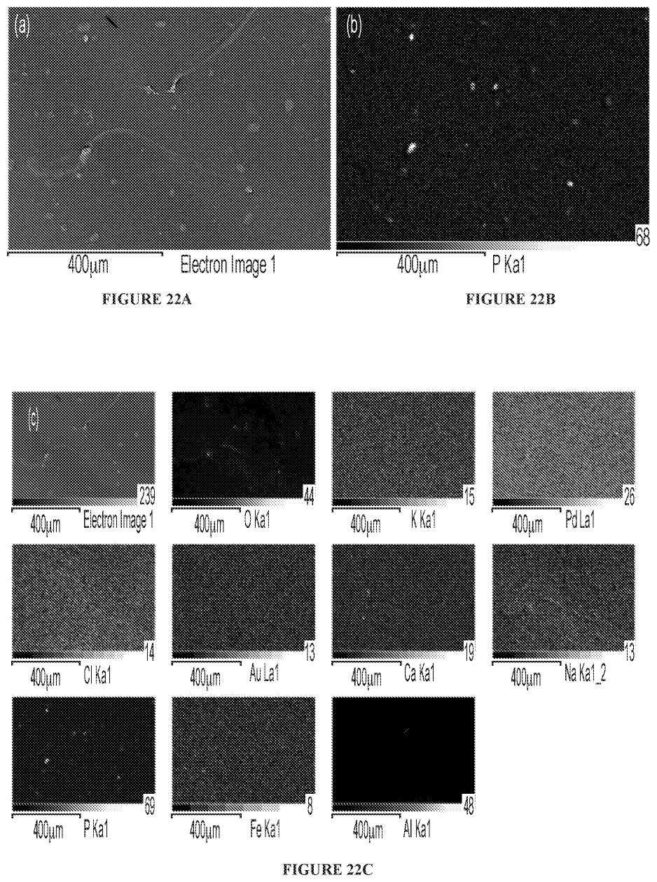

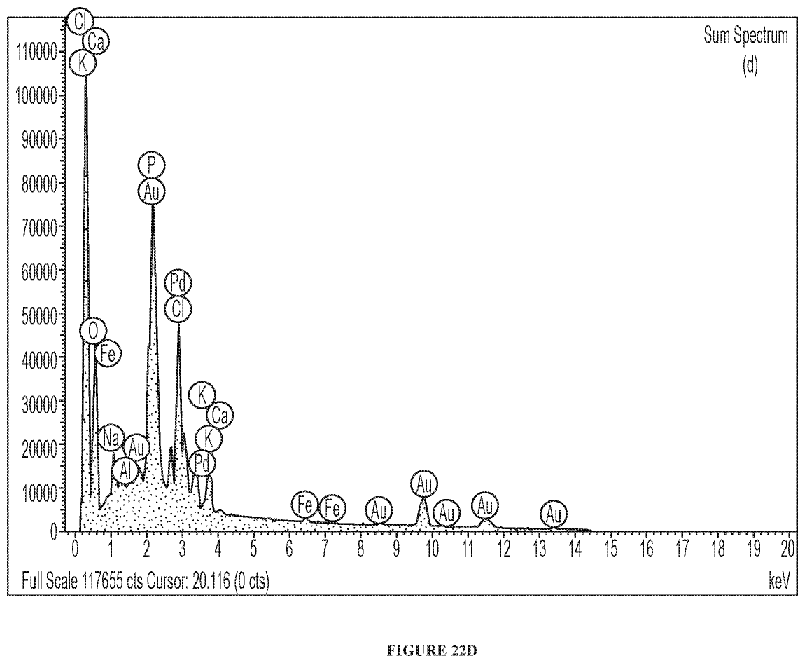

FIGS. 21A-22D illustrate energy dispersive X-ray spectroscopy of a 4 hour experiment sample. In particular, FIG. 22A illustrates an electron image, FIG. 21B illustrates surface mapping of Phosphorous (P) distribution, FIG. 21C illustrates elemental mapping, and FIG. 21D illustrates the spectrum of elemental composition.

FIGS. 21A-D and 22A-D depict the EDS report of a 4 hour blank and experiment samples respectively. As shown in FIGS. 21B and 22B, it is again shown that exposure to EMF assists in crystal formation and assists in the capture of phosphorous. From the elemental composition it can be determined that the EDS detected phosphorous around 60,000 times in the control sample, but it detected phosphorous over 85,000 times in the EMF exposed sample. FIG. 21A, 21C and FIG. 22A, 22C are the electron microscope images of the examined surface and entire elemental mapping for control and treated sample.

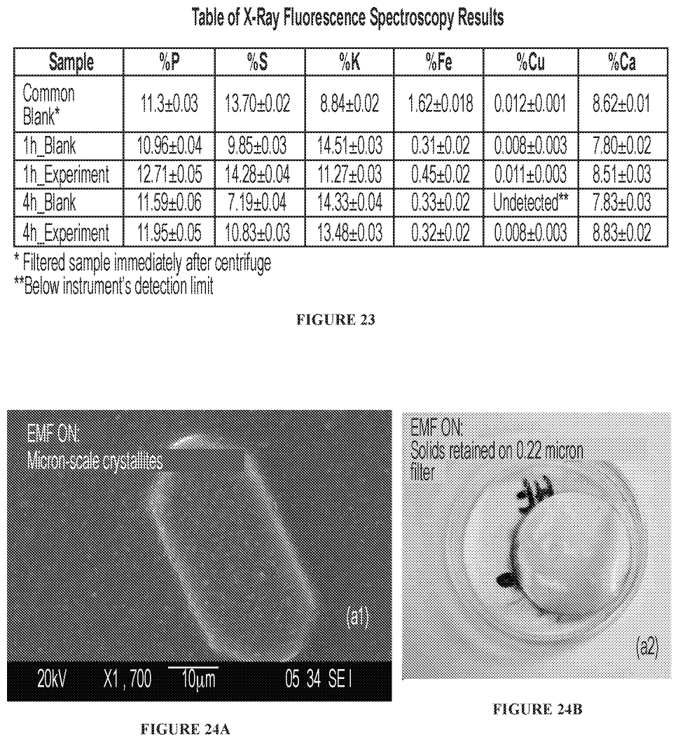

X-ray Fluorescence Spectroscopy—X-ray fluorescence spectrometer (XRF) is widely used for semi-quantitative determination of elemental and chemical composition of a solid material (i.e. crystals, metals, glass etc.) XRF was carried out to evaluate the elemental composition of both the control and the treatment sample crystals. The results are given in the Table shown in FIG. 23.

From the XRF data, it is evident that Phosphorous (P), and Sulfur (S) content increased and Potassium (K) content decreased in the crystal compared to crystals of the control. Thus, the Phosphorous and Sulfur content in the EMF treated sample water is lower than the control sample. The results are analogous to the colorimetric orthophosphate test where it was found that Phosphorous was reduced in the EMF treated sample.

The overall results from the colorimetric test, SEM and EDS analysis and XRF spectrometer indicate that PDT is capable of destabilizing phosphorous in the wastewater and potentially help to crystallize them to form struvite as well as other crystals. It is contemplated that the addition of magnesium (Mg) to the water stream flow may help the phosphorus (P) particles form/cluster better on the membrane.

### Experiment 2

The centrate water sample was composed of magnesium (21 mg/L), ammonia (990 mg/L), and phosphorus (130 mg/L, dissolved), which are commonly known as MAP or struvite-forming constituents. In addition, 48 mg/L calcium and 7.1 mg/L iron were also present. The pH of the centrate water was 7.54 at 22.7° C.

First, 40 mL centrate samples were centrifuged at 10,000 rpm for 30 minutes to remove suspended solids. Then, the supernatant was decanted and filtered using 0.45-micron membrane to obtain a sample free of suspended solids. The filtered supernatant was then treated for 4 hours with 150 kHz oscillating electric field delivered by PDT. The PDT device with centrate water sample is taped inside the ferrite rings. The supernatant sample that was not exposed to the electric signal served as a control. After 4 hours of exposure to the electric signal, the samples were immediately filtered using 0.45-micron filter to retain the electric field-induced struvite and other crystallites on the filter surface. The filter with retained crystallites (or solids) were air dried and analyzed for chemical composition using scanning electron microscopy (SEM) and energy dispersive spectroscopy (EDS). The settled solids with and without EMF were also analyzed using X-ray fluorescence (XRF) microscopy. The SEM was used to determine the crystal morphology, EDS was used to determine the composition of crystallites, and XRF was used to measure the composition of the settle solids. The analyses were conducted on both the control and electric field treated samples.

Results—Supernatant Analysis—The supernatant samples were treated with EMF and filtered using 0.22-micron filter. FIGS. 24A and 24B illustrate the EMF exposed supernatant samples from Experiment 2. In particular, high-resolution scanning electron microscopy images of the sample on the membrane filter is shown in FIG. 24A. This sample has several crystalline solids spread across the membrane surface. A photograph of the retained solids on the membrane is shown in FIG. 24B. The solids appear as brown-colored material on the membrane surface, which suggests that EMF likely increased the concentration of suspended solids compared to control sample in FIG. 24B.

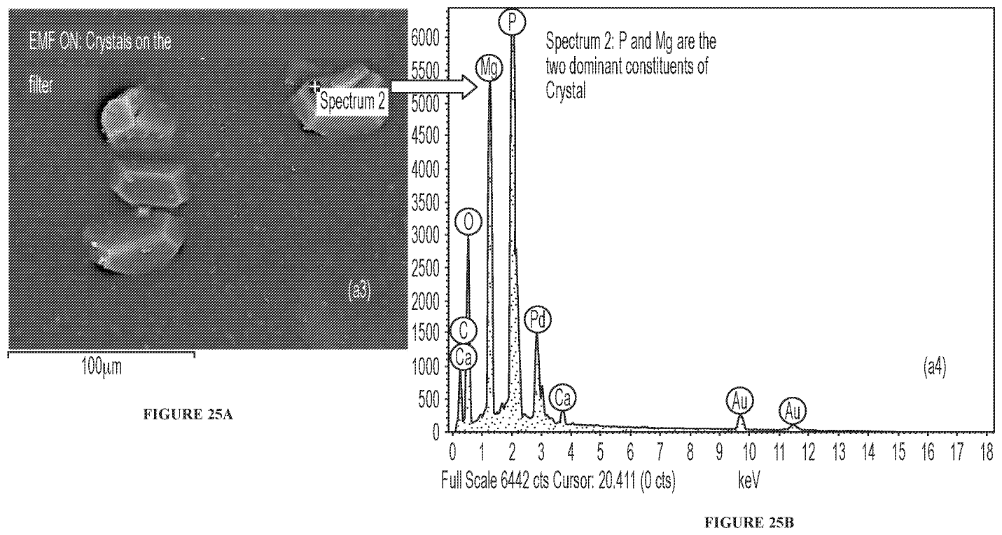

FIG. 25A illustrates SEM showing the crystal morphology of large-sized crystals, and FIG. 25B illustrates Energy Dispersive Spectroscopy showing the elemental composition of a crystal. In particular, FIG. 25A illustrates another scanning electron micrograph of crystallites in supernatant samples after exposure to EMF. The energy dispersive spectroscopy (EDS) analysis was conducted on a crystal at a location shown as ‘+’ in FIG. 25A. A spectrum of elemental composition at that ‘+’ location is shown in FIG. 25B. The spectrum shows that P, Mg, and O elements are the dominant constituents of the crystal, which suggests that the crystal could be struvite.

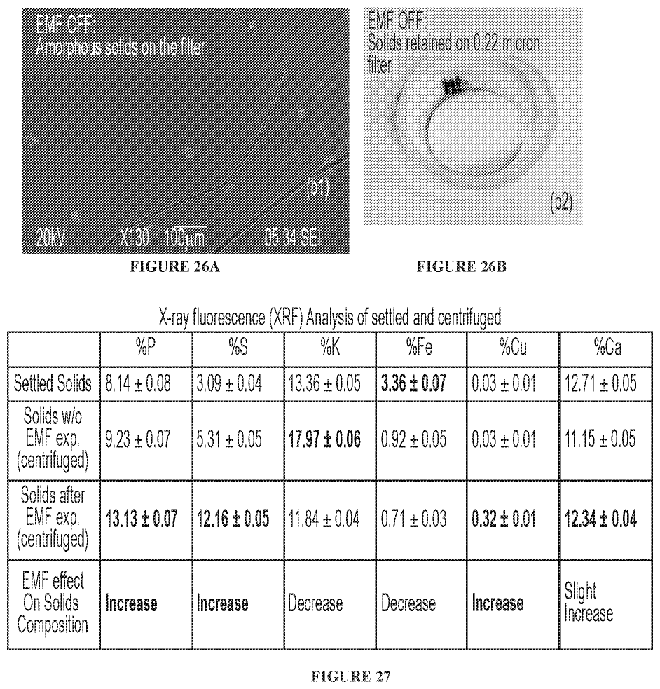

FIGS. 26A and 26B illustrate the control supernatant sample without EMF treatment. In particular, FIGS. 26A and 26B illustrate the scanning electron microscopy image and a photograph of the control supernatant sample. Supernatant samples, without treatment with EMF, were filtered using 0.22-micron filter. FIG. 26A illustrates high-resolution scanning electron microscopy image of the retained solids on the membrane surface. This sample has a lower amount of crystalline solids and higher amount amorphous material spread across the membrane surface. A photograph of the retained solids on the membrane is shown in FIG. 26B. The solids appear as lighter-colored material on the membrane surface compared to FIG. 24B, which suggests that the control supernatant likely has a higher concentration of dissolved species than the EMF treated sample.

Suspended Solids Analysis—The treatment conditions are listed in column 1 of the Table shown in FIG. 27 and are as follows:

“Settled solids” means the suspended solids in the centrate samples were allowed to gravity settle for 4 hours. About 90% of the supernatant was decanted and the remaining supernatant with settled solids was filtered using a 0.22-micron membrane. The filtration was conducted to dewater the solids.

“Solids w/o EMF exp. (centrifuged)” means the centrate sample was centrifuged to collect the solids at the bottom of the vial. About 90% of the supernatant was decanted and the remaining supernatant with settled solids was filtered using a 0.22-micron membrane. The filtration was conducted to dewater the solids.

“Solids after EMF exp. (centrifuged)” means the centrate sample was exposed to 4 hours and then centrifuged to collect the solids at the bottom of the vial. About 90% of the supernatant was decanted and the remaining supernatant with settled solids was filtered using a 0.22-micron membrane. The filtration was conducted to dewater the solids. When EMF produces settlable minerals from dissolved species then the concentration of certain elements should increase in the settled solids, e.g., P concentration and others.

All membrane samples with settled solids were analyzed using X-ray fluorescence techniques and the percent composition of selected elements is shown in the table shown in FIG. 27. The results show that in the presence of EMF:
1. The percent phosphorus in the settled solids increased to 13% from 9% (control)
2. The percent sulfur in the settled solids increased to 12% from 5% (control)
3. The percent calcium in the settled solids slightly increased to 12% from 11% (control)
4. The percent copper in the settled solids increased to 0.32% from 0.03% (control)
   Preliminary Solids Recovery Analysis—The above results suggest that the PDT (Hydroflow unit) can enhance the precipitation of solids compared to control samples. For example, filtration of the control and the EMF-treated supernatant samples showed the following:
1. Control sample: the weight of the solids retained on the membrane surface was 0.1722 g/80 mL filtered
2. EMF-treated sample: the weight of the solids retained on the membrane surface was 0.4576 g/80 ml filtered

Thus, the EMF treatment of wastewater enhanced the amount of solids retained on the membrane surface. This is consistent with photographic and SEM evidence. Moreover, XRF analysis also suggested that P-concentration in settled solids is higher (13%) compared to the control samples (9%). This result further supports that the EMF is responsible for P increase in the solids.

Based on the above results, the EMF has the potential to increase the suspended solids concentration (or reduce the dissolved species concentration) in centrate water samples, and since the P-containing minerals are in micron-scale it is possible to recovery the minerals using cross-flow microfiltration.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

### REFERENCES

Additional references are cited in Specification and Examples, and all are incorporated by reference in their entirety.
1. Anderson, P. R., Benjamin, M. M. and Lawler, D. F. (2013) Water Quality Engineering: Physical and Chemical Treatment Processes, pp. 379-434, John Wiley & Sons, Inc., New Jersey.
2. Appiani, E., Ossola, R., Latch, D. E., Erickson, P. R. and McNeill, K. (2017) Aqueous singlet oxygen reaction kinetics of furfuryl alcohol: effect of temperature, pH, and salt content. Environmental Science-Processes & Impacts 19(4), 507-516.
3. Arnal, J. M., Garcia-Fayos, B. and Sancho, M. (2011) Exapanding Issues in Desalination. Ning, R. Y. (ed), pp. 63-84, InTech.
4. Badireddy, A. R. (2016) Effects of surface topography and low-frequency electric fields on bioadhesion. Abstracts of Papers of the American Chemical Society 252.
5. Badireddy, A. R., Budarz, J. F., Chellam, S. and Wiesner, M. R. (2012) Bacteriophage inactivation by UV-A illuminated fullerenes: Role ofnanoparticle-virus association and biological targets. Environ. Sci. Technol.
6. Badireddy, A. R., Chellam, S., Gassman, P. L., Engelhard, M. H., Lea, A. S. and Rosso, K. M. (2010) Role of extracellular polymeric substances in bioflocculation of activated sludge microorganisms under glucose-controlled conditions. Water Research 44(15), 4505-4516.
7. Badireddy, A. R., Chellam, S., Yanina, S., Gassman, P. and Rosso, K. M. (2008a) Bismuth dimercaptopropanol (BisBAL) inhibits the expression of extracellular polysaccharides and proteins by Brevundimonas diminuta: Implications for membrane microfiltration. Biotechnology and Bioengineering 99(3), 634-643.
8. Badireddy, A. R., Hotze, E. M., Chellam, S., Alveraz, P. J. J. and Wiesner, M. R. (2007) Inactivation of bacteriophages viaphotosensitizationoffullerolnanoparticles.

Environmental Science and Technology 41, 6627-6632.
9. Badireddy, A. R., Korpol, B., Chellam, S., Gassman, P. L., Engelhard, M. H., Lea, A. S. and Rosso, K. M. (2008b) Spectroscopic characterization of extracellular polymeric substances from Escherichia coli and Serratia marcescens: suppression using sub-inhibitory concentrations of bismuth thiols. Biomacromolecules 9, 3079-3089.
10. Badireddy, A. R., Marinakos, S. M., Chellam, S. and Wiesner, M. R. (2013) Lipophilic nano-bismuth inhibits bacterial growth, attachment, and biofilm formation. Surface Innovations 1(3), 181-189.
11. Bagheri, M. and Mirbagheri, S. A. (2018) Critical review of fouling mitigation strategies in membrane bioreactors treating water and wastewater. Bioresource Technology 258, 318-334.
12. Bird, R. B., Stewart, W. E. and Lightfoot, E. N. (2002) Transport Phenomena, John Wiley & Sons, Inc., New York.
13. Bowen, W. R. and Jenner, F. (1995) Dynamic ultrafiltration model for charged colloidal dispersion—A Wigner-Seitz cell approach. Chemical Engineering Science 50(11), 1707-1736.
14. Bowen, W. R. and Williams, P. M. (1996) The osmotic pressure of electrostatically stabilized colloidal dispersions. Journal of Colloid and Interface Science 184(1), 241-250.
15. Bowen, W. R., Yousef, H. N. S. and Calvo, J. I. (2001) Dynamic cross flow ultrafiltration of colloids: a deposition probability cake filtration approach. Separation and Purification Technology 24(1-2), 297-308.
16. Chu, C. H., Erickson, P. R., Lundeen, R. A., Stamatelatos, D., Alaimo, P. J., Latch, D. E. and McNeill, K. (2016) Photochemical and nonphotochemical transformations of cysteine with dissolved organic matter. Environmental Science & Technology 50(12), 6363-6373.
17. Cogan, N. G., Li, J., Badireddy, A. R. and Chellam, S. (2016) Optimal backwashing in dead-end bacterial microfiltration with irreversible attachment mediated by extracellular polymeric substances production. Journal of Membrane Science 520, 337-344.
18. Enevoldsen, A. D., Hansen, E. B. and Jonsson, G. (2007) Electro-ultrafiltration of industrial enzyme solutions. Journal of Membrane Science 299(1-2), 28-37.
19. Erdim, E., Badireddy, A. R. and Wiesner, M. R. (2014) Characterization of reactive oxygen species generation by zerovalent iron-fullerene nanocomposite under UV-Illumination and neutral pH. Journal of Hazardous Materials Just accepted.
20. Field, R. (2010) Membranes for Water Treatment. Peinemann, K.-V. and Nunes, S. P. (eds), Wiley-VCH Verlag GmbH & Co.
21. Fojt, L., Strasak, L. and Vetterl, V. (2007) Effect of electromagnetic fields on the denitrification activity of Paracoccus denitrificans. Bioelectrochemistry 70(1), 91-95.
22. Formoso, P., Pantuso, E., De Filpo, G. and Nicoletta, F. P. (2017) Electro-conductive membranes for permeation enhancement and fouling mitigation: A short review. Membranes 7(3), 24.
23. Gabrielyan, L., Sargsyan, H. and Trchounian, A. (2016) Biohydrogen production by purple non-sulfur bacteria Rhodobacter sphaeroides: Effect of low-intensity electromagnetic irradiation. Journal of Photochemistry and Photobiology B: Biology 162, 592-596.
24. Gad, A. and Jayaram, S. H. (2014) Effect of electric pulse parameters on releasing metallic particles from stainless steel electrodes during PEF processing of milk. Ieee Transactions on Industry Applications 50(2), 1402-1409.
25. Gao, W., Liang, H., Ma, J., Han, M., Chen, Z.-l., Han, Z.-s. and Li, G.-b. (2011) Membrane fouling control in ultrafiltration technology for drinking water production: A review. Desalination 272(1), 1-8.
26. Hoek, E. M. V., Allred, J., Knoell, T. and Jeong, B.-H. (2008) Modeling the effects of fouling on full-scale reverse osmosis processes. Journal of Membrane Science 314(1), 33-49.
27. Hunter, R. J. (1981) Zeta Potential in Colloid Science: Principles and Applications, Academic Press, London.
28. Huotari, H. M., Tragardh, G. and Huisman, I. H. (1999) Cross flow Membrane Filtration Enhanced by an External DC Electric Field: A Review. Chemical Engineering Research and Design 77(5), 461-468.
29. Janssen, E. M. L., Marron, E. and McNeill, K. (2015) Aquatic photochemical kinetics of benzotriazole and structurally related compounds. Environmental Science-Processes & Impacts 17(5), 939-946.
30. Jianguo, W., Yan, F., Xuemeng, Z. and Xiaomei, L. (2012) Effects of Alternating Electromagnetic Field on Calcium Carbonate Scaling Process. Jiang, L. (ed), pp. 527-534, Springer Berlin Heidelberg, Berlin, Heidelberg.
31. Jonsson, G. and Macedonio, F. (2010) Comprehensive Membrane Science and Engineering. Drioli, E. and Giorno, L. (eds), pp. 1-22, Elsevier, New York.
32. Kang, S., Herzberg, M., Rodrigues, D. F. and Elimelech, M. (2008) Antibacterial effects of carbon nanotubes: Size does matter. Langmuir 24(13), 6409-6413.
33. Kim, H. J., Choi, K., Baek, Y., Kim, D.-G., Shim, J., Yoon, J. and Lee, J.-C. (2014) High-performance reverse osmosis CNT/polyamide nanocomposite membrane by controlled interfacial interactions. ACS Applied Materials & Interfaces 6(4), 2819-2829.
34. Le Corre K. S., Jones E. V., Hobbs P., Jefferson B., Parsons S. A.; Struvite crystallisation and recovery using a stainless steel structure as a seed material; Water Res; 2007; 41; 2449-2456.
35. Li, J., Liu, J., Yang, T. and Xiao, C. (2007) Quantitative study of the effect of electromagnetic field on scale deposition on nanofiltration membranes via UTDR.

Water Research 41(20), 4595-4610.
36. Li, M. F., Bradley, J. C., Badireddy, A. R. and Lu, H. J. (2017) Ultrafiltration membranes functionalized with lipophilic bismuth dimercaptopropanol nanoparticles: Anti-fouling behavior and mechanisms. Chemical Engineering Journal 313, 293-300.
37. Lin, J. C.-T., Lee, D.-J. and Huang, C. (2010) Membrane fouling mitigation: Membrane cleaning. Separation Science and Technology 45(7), 858-872.
38. Lutz, H. (2010) Comprehensive Membrane Science and Engineering. Drioli, E. and Giorno, L. (eds), pp. 115-140, Elsevier, New York.
39. Mallevialle, J., Odendaal, P. E. and Wiesner, M. R. (1996) Water Treatment Membrane Processes, McGraw-Hill Professional, American Water Works Association Research Foundation, Lyonnaise des Eaux, Water Research Commision of South Africa.
40. Martell, A., Smith, R. and Motekaitis, R. (1998) Critically selected stability constants of metal complexes, NIST Standard Reference Database 46, Texas A&M University.
41. Masliyah, J. H. and Bhattacharjee, S. (2006) Electrokinetic and Colloid Transport Phenomena, John Wiley & Sons, Inc., Hoboken, N.J.
42. Morel, F. M. M. (1983), p. 244, Wiley, New York.
43. Ohlinger, K. N., Young, T. M. and Schroeder, E. D. (1998) Predicting struvite formation in digestion. Water Research 32, 3607-3614.
44. Page, S. E., Arnold, W. A. and McNeill, K. (2010) Terephthalate as a probe for photochemically generated hydroxyl radical. Journal of Environmental Monitoring 12(9), 1658-1665.
45. Pasquini, L. M., Hashmi, S. M., Sommer, T. J., Elimelech, M. and Zimmerman, J. B. (2012) Impact of surface functionalization on bacterial cytotoxicity of single-walled carbon nanotubes. Environmental Science & Technology 46(11), 6297-6305.
46. Perreault, F., de Faria, A. F., Nejati, S. and Elimelech, M. (2015) Antimicrobial properties of graphene oxide nanosheets: Why size matters. ACS Nano 9(7), 7226-7236.
47. Piyadasa, C., Yeager, T. R., Gray, S. R., Stewart, M. B., Ridgway, H. F., Pelekani, C. and Orbell, J. D. (2016) The effect of electromagnetic fields, from two commercially available water treatment devices, on bacterial culturability. Water Science and Technology 73(6), 1371-1377.
48. Piyadasa, C., Yeager, T. R., Gray, S. R., Stewart, M. B., Ridgway, H. F., Pelekani, C. and Orbell, J. D. (2018) Antimicrobial effects of pulsed electromagnetic fields from commercially available water treatment devices—controlled studies under static and flow conditions. Journal of Chemical Technology and Biotechnology 93(3), 871-877.
49. Porcelli, N. and Judd, S. (2010) Chemical cleaning of potable water membranes: A review. Separation and Purification Technology 71(2), 137-143.
50. Profio, G. D., Curcio, E. and Drioli, E. (2010) Comprehensive Membrane Science and Engineering. Drioli, E. and Giorno, L. (eds), pp. 21-44, Elsevier.
51. Programme, U. N. D. (2006) Human Development Report 2006: Beyond Scarcity” Power, Poverty and the Global Water Crisis, New York.
52. Prywer J., Sieron L., Czylkowska A; Struvite Grown in Gel, Its Crystal Structure at 90K and Thermoanalytical Study; Crystal; 2019; 9(2); 89.
53. Prywer J., Torzewska A, Plocinski T; Unique surface and internal structure of struvite crystals formed by Proteus mirabilis; Urol. Res. 2012; 40(6); 699-707.
54. Rouina, M., Kariminia, H.-R., Mousavi, S. A. and Shahryari, E. (2016) Effect of electromagnetic field on membrane fouling in reverse osmosis process. Desalination 395, 41-45.
55. Ruiz-Garcfa, A. and Ruiz-Saavedra, E. (2015) 80,000 h operational experience and performance analysis of a brackish water reverse osmosis desalination plant.

Assessment of membrane replacement cost. Desalination 375, 81-88.
56. Sablani, S. S., Goosen, M. F. A., Al-Belushi, R. and Wilf, M. (2001) Concentration polarization in ultrafiltration and reverse osmosis: a critical review. Desalination 141(3), 269-289.
57. Saha, S. K. and Brewer, C. F. (1994) Determination of the concentrations of oligosaccharides, complex type carbohydrates, and glycoproteins using the phenol sulfuric-acid method. Carbohydrate Research 254, 157-167.
58. Shannon, M. A., Bohn, P. W., Elimelech, M., Georgiadis, J. G., Marinas, B. J. and Mayes, A. M. (2008) Science and technology for water purification in the coming decades.

Nature 452, 301.
59. Shirazi, S., Lin, C. J. and Chen, D. (2010) Inorganic fouling of pressure-driven membrane processes—A critical review. Desalination 250(1), 236-248.
60. Song, L. F., Chen, K. L., Ong, S. L. and Ng, W. J. (2004) A new normalization method for determination of colloidal fouling potential in membrane processes. Journal of Colloid and Interface Science 271(2), 426-433.
61. Tay, K. G. and Song, L. (2005) A more effective method for fouling characterization in a full-scale reverse osmosis process. Desalination 177(1), 95-107.
62. Tessaro, L. W. E., Murugan, N. J. and Persinger, M. A. (2015) Bacterial growth rates are influenced by cellular characteristics of individual species when immersed in electromagnetic fields. Microbiological Research 172, 26-33.
63. Tijing, L. D., Lee, D.-H., Kim, D.-W., Cho, Y. I. and Kim, C. S. (2011) Effect of high-frequency electric fields on calcium carbonate scaling. Desalination 279(1), 47-53.
64. Torgomyan, H. and Trchounian, A. (2013) Bactericidal effects of low-intensity extremely high frequency electromagnetic field: an overview with phenomenon, mechanisms, targets and consequences. Critical Reviews in Microbiology 39(1), 102-111.
65. Torgomyan, H. and Trchounian, A. (2015) The enhanced effects of antibiotics irradiated of extremely high frequency electromagnetic field on Escherichia coli growth properties. Cell Biochemistry and Biophysics 71(1), 419-424.
66. Wiesner, M. R. and Chellam, S. (1999) Peer Reviewed: The promise of membrane technology. Environmental Science & Technology 33(17), 360A-366A.
67. X., X., M., C. and C., Y. (2005) Investigation on the Electromagnetic Anti-Fouling Technology for Scale Prevention. Chemical Engineering & Technology 28(12), 1540-1545.
68. Xing, X. K., Ma, C. F. and Chen, Y. C. (2005) Investigation on the electromagnetic anti-fouling technology for scale prevention. Chemical Engineering & Technology 28(12), 1540-1545.
69. Zhang, P., Cheng, S. and Guo, B. (2009) Effect of Rotating-Electromagnetic Field on Scaling in Hard Water, pp. 614-617.
70. Zhang, R., Liu, Y., He, M., Su, Y., Zhao, X., Elimelech, M. and Jiang, Z. (2016) Antifouling membranes for sustainable water purification: strategies and mechanisms.

Chemical Society Reviews 45(21), 5888-592
71. Zhang, W. X., Luo, J. Q., Ding, L. H. and Jaffrin, M. Y. (2015) A review on flux decline control strategies in pressure-driven membrane processes. Industrial & Engineering Chemistry Research 54(11), 2843-2861.
72. Zhou, M. J., Diwu, Z. J., PanchukVoloshina, N. and Haugland, R. P. (1997) A stable nonfluorescent derivative of resorufin for the fluorometric determination of trace hydrogen peroxide: Applications in detecting the activity of phagocyte NADPH oxidase and other oxidases. Analytical Biochemistry 253(2), 162-168.

What is claimed is:

1. An electric filtration cell, for use in a water treatment system, the electric filtration cell configured to separate charged compositions from a water stream, the electric filtration cell comprising:
a fluid passageway;
a filtration membrane positioned within the passageway; and
a first electrode and a second electrode, wherein the first and second electrodes are configured to selectively provide an oscillating electric field across the filtration membrane to separate charged compositions on a first side of the filtration membrane.

2. The electric filtration cell of claim 1, wherein the first electrode is integrally formed with the filtration membrane.

3. The electric filtration cell of claim 2, wherein the first electrode and the filtration membrane are formed of carbon nanotubes.

4. The electric filtration cell of claim 3, wherein the first electrode and the filtration membrane are formed of carboxyl-functionalized multi-walled carbon nanotubes (MWCNT).

5. The electric filtration cell of claim 1, wherein the filtration membrane further comprises a porous polycarbonate structure.

6. The electric filtration cell of claim 1, wherein the second electrode is formed of graphite paper.

7. The electric filtration cell of claim 1, wherein the first electrode and the filtration membrane are separately formed components.

8. The electric filtration cell of claim 7, wherein the filtration membrane is positioned between the first electrode and the second electrode.

9. The electric filtration cell of claim 1, further comprising an Alternating-Current (AC) power source configured to selectively provide an oscillating electric field across the filtration membrane.

10.-15. (canceled)

16. The electric filtration cell of claim 1, wherein the electric field strength of the oscillating electric field across the filtration membrane is at least 400 V/in, or at least 600 V/m, or at least 800 V/in, or at least 1000 V/m, or at least 1200 V/in, or at least 1400 V/m.

17. The electric filtration cell of claim 1, wherein the frequency of the oscillating electric field across the filtration membrane is at least 0.5 Hz, or at least 1 Hz, or at least 10 Hz, or at least 20 Hz.

18. A water treatment system configured to separate charged compositions from a water stream, the water treatment system comprising:
a fluid passageway;
an electromagnetic field (EMF) device coupled to the passageway and configured to selectively generate an electromagnetic field within the passageway;
a filtration membrane positioned within the passageway; and
a first electrode and a second electrode, wherein the first and second electrodes are configured to selectively provide an oscillating electric field across the filtration membrane to separate charged compositions on a first side of the filtration membrane.

19. The water treatment system of claim 18, wherein the EMF device is configured to induce a signal into the passageway at a frequency of at least 1 kHz, or at least 20 kHz, or at least 100 kHz.

20. The water treatment system of claim 18, further comprising a peristaltic pump configured to flow water through the passageway.

21. The water treatment system of claim 18, wherein the first electrode is integrally formed with the filtration membrane.

22. The water treatment system of claim 21, wherein the first electrode and the filtration membrane are formed of carbon nanotubes.

23. The water treatment system of claim 22, wherein the first electrode and the filtration membrane are formed of carboxyl-functionalized multi-walled carbon nanotubes (MWCNT).

24. The water treatment system of claim 18, wherein the filtration membrane further comprises a porous polycarbonate structure.

25.-37. (canceled)

38. A method of using a filtration membrane in a water treatment system to separate charged compositions from a water stream, the method comprising:
providing a filtration membrane in a fluid passageway;
flowing a fluid through the fluid passageway and through the filtration membrane; and
generating an oscillating electromagnetic field across the filtration membrane to alter compositions in the fluid, such that the altered compositions remain on a first side of the filtration membrane.

39.-45. (canceled)

46. The method of claim 38, further comprising generating an electromagnetic field within the passageway at a location upstream from the filtration membrane to pretreat the water stream prior to the filtration membrane to enable the charged compositions to precipitate out of solution.

47.-57. (canceled)
